(19) United States
(12) Patent Application Publication
(10) Pub. No.: US 2024/0179692 A1
(43) Pub. Date: May 30, 2024

(54) TIME-DOMAIN RESOURCE ALLOCATION FOR TRANSPORT BLOCK OVER MULTIPLE SLOT (TBOMS) TRANSMISSIONS

(71) Applicant: Intel Corporation, Santa Clara, CA (US)

(72) Inventors: Gang Xiong, Portland, OR (US); Debdeep Chatterjee, San Jose, CA (US); Gregory Ermolaev, Nizhny Novgorod (RU); Sergey Sosnin, Zavolzhie (RU); Jie Zhu, San Jose, CA (US)

(21) Appl. No.: 18/549,329

(22) PCT Filed: Mar. 22, 2022
(86) PCT No.: PCT/US2022/021362

§ 371 Date: Sep. 6, 2023

Related U.S. Application Data
(60) Provisional application No. 63/164,841, filed on Mar. 23, 2021.
(60) Provisional application No. 63/174,951, filed on Apr. 14, 2021.
(60) Provisional application No. 63/243,871, filed on Sep. 14, 2021.

(51) Int. Cl. H04W 72/0446

(52) U.S. Cl. CPC H04W 72/0446

(57) ABSTRACT

Various embodiments are directed to time-domain resource allocation for transport block over multiple slot (TBoMS) transmissions. An apparatus may comprise: memory to store configuration information that includes a shared time domain resource allocation (TDRA) list associated with transport block over multiple slot (TBoMS) processing; and processing circuitry, coupled with the memory, to: retrieve the configuration information from the memory, wherein the TDRA list includes an entry having an indication of a scheduling delay (k2) and number of slots (N) for a TBoMS transmission; and encode a message for transmission to a user equipment (UE) that includes the configuration information. Other embodiments may be disclosed or claimed.

### CROSS REFERENCE TO RELATED APPLICATION

The present application claims priority to: U.S. Provisional Patent Application No. 63/164,841, which was filed Mar. 23, 2021; U.S. Provisional Patent Application No. 63/174,951, which was filed Apr. 14, 2021; and U.S. Provisional Patent Application No. 63/243,871, which was filed Sep. 14, 2021.

### FIELD

Various embodiments generally may relate to the field of wireless communications. For example, some embodiments may relate to time-domain resource allocation for transport block over multiple slot (TBoMS) transmissions.

### BACKGROUND

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that target to meet vastly different and sometime conflicting performance dimensions and services. Such diverse multi-dimensional requirements are driven by different services and applications. In general, NR will evolve based on 3GPP LTE-Advanced with additional potential new Radio Access Technologies (RATs) to enrich people lives with better, simple and seamless wireless connectivity solutions. NR will enable everything connected by wireless and deliver fast, rich content and services.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 illustrates an example of a Type A based mechanism for TDRA of TBoMS in accordance with various embodiments.

FIG. 2 illustrates an example of a Type B based mechanism for TDRA of TBoMS in accordance with various embodiments.

FIG. 3 illustrates a first example of a DMRS pattern for Type B based TDRA for TBoMS in accordance with various embodiments.

FIG. 4 illustrates a second example of a DMRS pattern for Type B based TDRA for TBoMS in accordance with various embodiments.

FIG. 5 illustrates a first example of handling overlapping between TBoMS and other physical channels/signals in accordance with various embodiments.

FIG. 6 illustrates a second example of handling overlapping between TBoMS and other physical channels/signals in accordance with various embodiments.

FIG. 7 illustrates an example of a single transmission occasion of TBoMS when the gap is less than threshold in accordance with various embodiments.

FIG. 8 illustrates an example of multiple transmission occasions of TBoMS when the gap is greater than threshold in accordance with various embodiments.

FIG. 9 schematically illustrates a wireless network in accordance with various embodiments.

FIG. 10 schematically illustrates components of a wireless network in accordance with various embodiments.

FIG. 11 is a block diagram illustrating components, according to some example embodiments, able to read instructions from a machine-readable or computer-readable medium (e.g., a non-transitory machine-readable storage medium) and perform any one or more of the methodologies discussed herein.

FIGS. 12, 13, and 14 depict examples of procedures for practicing the various embodiments discussed herein.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A or B” and “A/B” mean (A), (B), or (A and B).

For cellular systems, coverage is an important factor for successful operation. Compared to long-term evolution (LTE) systems, new radio (NR) systems can be deployed at a relatively higher carrier frequency in frequency range 1 (FR1), e.g., at 3.5 GHz. In this case, coverage loss is expected due to larger path-loss, which makes it more challenging to maintain an adequate quality of service. Typically, uplink coverage is the bottleneck for system operation considering the low transmit power at the user equipment (UE) side.

For NR, dynamic grant and configured grant based physical uplink shared channel (PUSCH) transmissions are supported. For dynamic grant PUSCH transmissions, PUSCH is scheduled by DCI format 0_0, 0_1 or 0_2. Further, two types of configured grant PUSCH transmissions are specified. In particular, for Type 1 configured grant PUSCH transmissions, uplink (UL) data transmission is only based on radio resource control (RRC) (re)configuration without any layer 1 (L1) signaling. In particular, semi-static resource may be configured for one UE, which includes time and frequency resource, modulation and coding scheme, reference signal, etc. For Type 2 configured grant PUSCH transmissions, UL data transmission is based on both RRC configuration and L1 signaling to activate/deactivate UL data transmission, which is similar to semi-persistent (SPS) uplink transmission as defined in LTE.

In NR Rel-15, a number of repetitions can be configured for the transmission of PUSCH to help improve the coverage performance. When repetition is employed for the transmission of PUCCH and PUSCH, same time domain resource allocation (TDRA) is used in each slot. Further, inter-slot frequency hopping can be configured to improve the performance by exploiting frequency diversity. In Rel-16, the number of repetitions for PUSCH can be dynamically indicated in the DCI.

Further, in NR, a transport block (TB) carried by a PUSCH is scheduled within a slot or resource allocation of one data transmission is confined with a slot. In this case, transport block size (TBS) is determined based on the number of resource elements (RE) in a slot. To maintain a low code rate, a transport block may span more than one slots, where a smaller number of physical resource blocks (PRBs) may be allocated in frequency so as to improve link budget for PUSCH transmission. To support the transmission of a TB processing over multiple slots (TBoMS), certain design enhancements may need to be considered.

Among other things, embodiments of the present disclosure are directed to enhancements to transport block processing over multiple slots for physical uplink shared channel (PUSCH).

More specifically, some embodiments disclosed herein are directed to:
Indication of time domain resource allocation for TBoMS
DMRS pattern for TBoMS transmission
Mechanisms on handling overlapping between TBoMS and other physical signals/channels.
Configuration of overhead for TBS determination for TBoMS

### Indication of Time Domain Resource Allocation for TBoMS

As mentioned above, a transport block (TB) carried by a PUSCH is scheduled within a slot or resource allocation of one data transmission is confined with a slot. In this case, transport block size (TBS) is determined based on the number of resource elements (RE) in a slot. To maintain a low code rate, a transport block may span more than one slots, where a smaller number of physical resource blocks (PRBs) may be allocated in frequency so as to improve link budget for PUSCH transmission. To support the transmission of a TB processing over multiple slots (TBoMS), certain design enhancements may need to be considered.

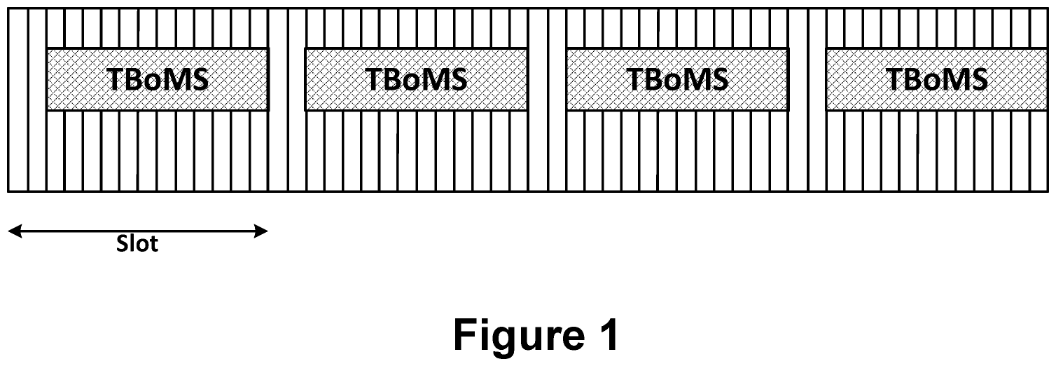

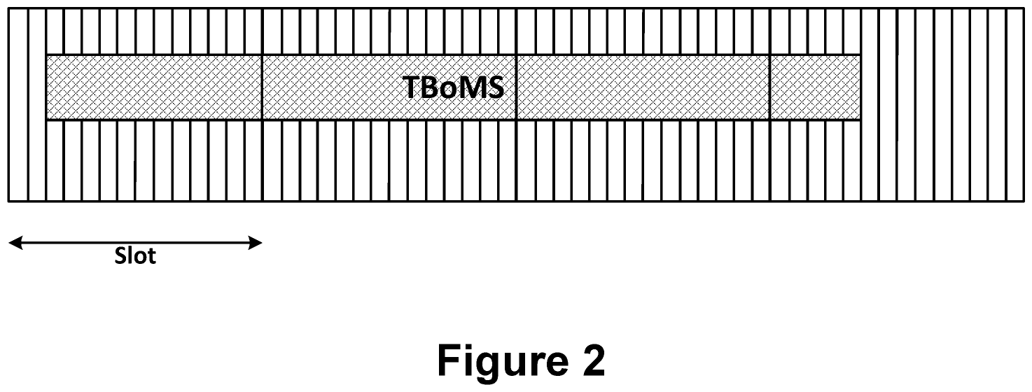

Note that for type A based mechanism for TDRA of TBoMS, same time domain resource allocation is allocated for TBoMS in each slot. For type B based mechanism for TDRA of TBoMS, consecutive symbols are allocated for TBoMS. FIG. 1 and FIG. 2 illustrate examples of type A and type B based mechanisms for TDRA of TBoMS, respectively.

Embodiments of indication of time domain resource allocation for TBoMS are provided as follows:

In one embodiment, for time domain resource allocation (TDRA) of TBoMS, both type A and type B based mechanisms can be supported. Whether type A or type B based mechanism is used for TBoMS can be configured by higher layers via minimum system information (MSI), remaining minimum system information (RMSI), other system information (OSI) or dedicated radio resource control (RRC) signalling or dynamically indicated in the downlink control information (DCI) or a combination thereof.

Note that for type A based TDRA for TBoMS, starting and length in Start and Length Indicator Value (SLIV) for each slot and number of slots for TBoMS can be configured as part of TDRA parameters, while for type B based TDRA for TBoMS, a long SLIV, which may span more than one slot can be configured as part of TDRA for TBoMS. In this case, length of TBoMS may be greater than 14 symbols for normal CP (NCP), or greater than 12 symbols for extended CP (ECP).

In addition, a maximum number of slots can be configured for TBoMS transmission, K, which can be also used to determine the number of bits for SLIV indication. More specifically, length of the TBoMS transmission can be less than the number of symbols for the maximum number of slots. The starting symbol of a TBoMS, S, is defined with respect to the starting symbol of a slot and can be within N_{symb}^{slot}=14 symbols for NCP (and N_{symb}^{slot}=12 symbols for ECP) of the first slot to which the TBoMS is mapped.

Next, consider an assigned TBoMS duration L, where Lₘᵢₙ≤L≤K*N_{symb}^{slot}, with Lₘᵢₙ is the minimum number of symbols for the TBoMS that may be assigned. In an example, Lₘᵢₙ=N_{symb}^{slot}. In another example, Lₘᵢₙ=N_{symb}^{slot} at least for Type A based mechanism for TDRA of TBoMS, while Lₘᵢₙ can be less than N_{symb}^{slot} for Type B mechanism for TDRA of TBoMS.

For such an assignment, in an embodiment, the TDRA for TBoMS can be indicated following currently specified SLIV mechanism for TDRA. That is, the starting symbol S relative to the start of the slot, and the number of consecutive symbols L counting from the symbol S allocated for the PUSCH are determined from the start and length indicator SLIV of the indexed row:

if (L − 1) ≤ floor(K*N_{symb}^{slot}/2) then
SLIV = K*N_{symb}^{slot} *(L−1)+ S
else
SLIV = K*N_{symb}^{slot} * (K*N_{symb}^{slot} − L + 1) + (K*N_{symb}^{slot} − 1 − S),
where 0 < Lₘᵢₙ ≤ L ≤ (K*N_{symb}^{slot} − S).

In an example of the embodiment, the above SLIV mechanism is applied only for Type B based mechanism for TDRA for TBoMS. For Type A based mechanism for TDRA for TBoMS, the single-slot SLIV determination is reused to indicate the allocation in each slot, and the number of slots over which the TBoMS is mapped is also provided to the UE.

In one example, as shown in the FIG. 2, starting symbol is symbol #2 in the first slot and the length of allocated TBoMS transmission is 45.

The above TDRA determination mechanism would result in significant signaling overhead with increasing K. Thus, in a variant of the embodiment, the SLIV can be defined using a minimum of ‘n’ consecutive symbols to compress the necessary signaling overhead at the cost of reduced flexibility in granularity of TDRA.

In another embodiment, if a UE is configured to support both type A and type B based mechanisms for TDRA of TBoMS, a subset of TDRA lists can be configured for either type A or type B based TDRA for TBoMS. When a UE is scheduled with an entry of the configured TDRA subset, UE can implicitly derive whether type A or type B based mechanism is used.

Table 1 illustrates one example of TDRA list partition to indicate the type A or type B based mechanism. In the example, in the TDRA list, entries from 0 to NO-1 are for TDRA list for TBoMS with type A based mechanism, while entries from N0 to N1-1 are for TDRA list for TBoMS with type B based mechanism. Note that N0 and N1 can be configured by higher layers via MSI, RMSI (SIB1), OSI or RRC signalling.

Based on this TDRA list partition, when a UE is scheduled with a TDRA entry within entry 0 to N0-1, UE can determine that type A based mechanism is used for TDRA of TBoMS. Similarly, when a UE is scheduled with a TDRA entry within entry NO to N1-1, UE can determine that type B based mechanism is used for TDRA of TBoMS.

TABLE 1
TDRA list partition to indicate the type A or type B based mechanism

| Entry index | TDRA list |
|---|---|
| Entry 0 | TDRA list for TBoMS with type A based mechanism |
| . . . | |
| Entry N₀-1 | |
| Entry N₀ | TDRA list for TBoMS with type B based mechanism |
| . . . | |
| Entry N₁-1 | |

In another embodiment, one bit indication can be included in the DCI to indicate whether to apply type A or type B based mechanism for TDRA of TBoMS. Note that this 1-bit indication may be included as part of TDRA for resource allocation. Alternatively, existing fields in the DCI may be re-purposed to indicate whether to apply type A or type B based mechanism for TDRA of TBoMS.

Table 2 illustrates one example of the indication of type A or type B based mechanism for TDRA of TBoMS.

TABLE 2
Indication of type A or type B based mechanism

| Identifier for TDRA | |
|---|---|
| type of TBoMS | Description |
| 0 | TBoMS with type A based mechanism |
| 1 | TBoMS with type B based mechanism |

In another option, indication whether to apply type A or type B based mechanism for TDRA of TBoMS can be configured by higher layers via MSI, RMSI (SIB1), OSI or RRC signalling per DCI format. In one example, when type A based mechanism is configured by higher layers via RRC signalling for DCI format 0_1, only type A based mechanism is used for TDRA of TBoMS when DCI format 0_1 is used to schedule TBoMS for PUSCH transmission. In another example, when type B based mechanism is configured by higher layers via RRC signaling for DCI format 0_2, only type B based mechanism is used for TDRA of TBoMS when DCI format 0_2 is used to schedule TBoMS for PUSCH transmission.

In yet another embodiment, the TDRA mapping type for TBoMS is implicitly determined by the UE based on the indicated TDRA—if the combination of the indicated starting symbol and duration indicates an allocation contained within a slot, the TDRA for the TBoMS is identified to follow TDRA mapping Type A, whereas if the combination of the indicated starting symbol and duration (via the SLIV indication) indicates an allocation that either crosses slot boundary or if the indicated duration is longer than 14 symbols (12 symbols for ECP), the TDRA for the TBoMS is identified to follow TDRA mapping Type B.

In one embodiment, a shared TDRA table can be configured for both TBoMS and single-slot PUSCH transmission with or without repetitions. Note that for the subset of TDRA list for TBoMS, number of slots for a single TBoMS transmission (N), number of repetitions (M), scheduling delay (k2), start and length indicator value (SLIV), and mapping type are configured in each row of the TDRA table for TBoMS. In cases where M is absent or not configured, repetition is not configured for the row of the TDRA table for TBoMS transmission.

For the subset of the TDRA list for single-slot PUSCH, a number of repetitions for PUSCH repetition, K2, SLIV and mapping type can be configured in each row of the TDRA table for single-slot PUSCH transmissions. Similarly, in case when number of repetitions for PUSCH is absent or not configured, repetition is not configured for the row of the TDRA table for single-slot PUSCH transmission. Further, a number of slots for a single TBoMS transmission or N=1 may be configured in one or more rows of TDRA table to indicate single-slot PUSCH transmission with or without repetitions.

In order to differentiate TBoMS and single-slot PUSCH transmission, in one option, one bit indication can be included as part of TDRA information in each row. In one example, bit “1” may be used to indicate that single-slot PUSCH transmission is scheduled and bit “0” may be used to indicate that TBoMS transmission is scheduled.

In another option, based on the TDRA list partitioning, e.g., when a UE is configured or scheduled with an entry of the configured TDRA subset, UE can implicitly derive whether TBoMS or single-slot PUSCH transmission is used.

Table 3 illustrates one example of TDRA list partition to indicate TBoMS or single-slot PUSCH transmission is scheduled. In the example, in the TDRA list, entries from 0 to P0-1 are for TDRA list for single-slot PUSCH transmission, while entries from P0 to P1-1 are for TDRA list for TBoMS transmission. Note that P0 and P1 can be configured by higher layers via MSI, RMSI (SIB1), OSI or RRC signalling.

Based on this TDRA list partition, when a UE is scheduled with a TDRA entry within entry 0 to P0-1, UE can determine that single-slot PUSCH transmission is scheduled. Similarly, when a UE is scheduled with a TDRA entry within entry P1 to P1-1, UE can determine that TBoMS transmission is scheduled.

TABLE 3
TDRA list partition to indicate the TBoMS
and single-slot PUSCH transmission

| Entry index | TDRA list |
|---|---|
| Entry 0 | TDRA list for single-slot PUSCH transmission |
| . . . | |
| Entry P₀-1 | |
| Entry P₀ | TDRA list for TBoMS transmission |
| . . . | |
| Entry P₁-1 | |

In another embodiment, separate TDRA tables can be configured for TBoMS and single-slot PUSCH transmission with or without repetitions, respectively. For the TDRA table which is configured for TBoMS, number of slots for a single TBoMS transmission (N), number of repetitions (M), k2, SLIV and mapping type can be configured in each row of the TDRA table for TBoMS.

Further, in order to allow dynamic switch between TBoMS and single-slot PUSCH transmission with or without repetition, number of slots for a single TBoMS transmission or N=1 may be configured in one or more rows of TDRA table to indicate single-slot PUSCH transmission with or without repetitions. In another option, number of slots for a single TBoMS transmission may not be configured in one or more rows of TDRA to indicate single-slot PUSCH transmission with or without repetitions. Note that in case of N=1 or when this parameter is not configured, number of repetitions (M) can be re-interpreted and applied for single-slot PUSCH transmission with repetitions.

In one option, one bit in the DCI can be used to indicate whether TBoMS or single-slot PUSCH transmission is scheduled. In particular, bit “1” may be used to indicate that single-slot PUSCH transmission is scheduled and bit “0” may be used to indicate that TBoMS transmission is scheduled. Further in case this field is not configured in the DCI, single-slot PUSCH transmission is scheduled as default configuration. Note that in case of TBoMS retransmission, gNB may switch from TBoMS transmission to single-slot PUSCH transmission with or without repetition, depending on the selected row in the TDRA table.

In another option, one or more of some reserved states in existing fields in the DCI can be used to indicate whether TBoMS or single-slot PUSCH transmission is scheduled.

In another option, separate RNTI can be used to schedule TBoMS transmission. In particular, this RNTI may be configured or indicated to the UE that is configured with TBoMS transmission. When UE receives the PDCCH with CRC scrambled by the RNTI, this indicates that TBoMS is scheduled. Further, for TBoMS transmission, initialization seed for the scrambling sequence generation is defined as a function of the configured/indicated RNTI for TBoMS transmission.

### DMRS Pattern for TBoMS Transmission

Embodiments of Demodulation reference signal (DMRS) pattern for TBoMS transmission are provided as follows:

For Type A based TDRA for TBoMS, the DMRS locations in each slot follows that in the first slot, which, in turn, is as indicated in the scheduling DCI format or configured via higher layers for Configured Grant PUSCH (CG PUSCH) following existing specifications.

In one embodiment, uniformly distributed DMRS symbols can be employed for the TBoMS transmission with Type B based TDRA. In particular, the distance between first symbol of front-loaded DMRS symbol(s) and additional symbol(s), as well as between additional symbol(s) can be configured by higher layers via MSI, RMSI (SIB1), OSI or RRC signalling or dynamically indicated in the DCI or a combination thereof. Based on the distance between the DMRS symbols and length of TBoMS transmission, UE can derive the additional DMRS symbol position.

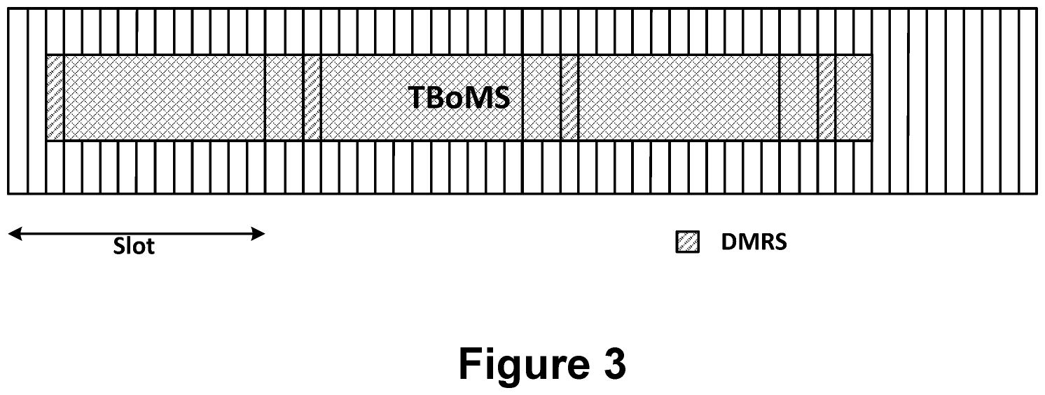

FIG. 3 illustrates one example of DMRS pattern for Type B based TDRA for TBoMS. In the example, TBoMS is allocated with 45 symbols. Further, distance between DMRS symbols is 14 symbols. In this case, DMRS is transmitted in the first symbol of TBoMS and every 14 symbols within TBoMS transmission.

In another variant of the above embodiment, UE may be provided with a number of DMRS symbols that are then equally-distributed-in-time over the TBoMS duration such that the first DMRS location is in the first symbol of the TBoMS. In an example, the TBoMS duration excludes any invalid symbol(s) in which the UE may not transmit within the TBoMS transmission duration. In another example, the TBoMS duration includes all valid and invalid symbols within the TBoMS transmission duration.

In another embodiment, when type B based TDRA mechanism is used for TBoMS, for the TBoMS transmission in the first slot, front loaded DMRS or DMRS in the first symbol of TBoMS transmission is employed. For the subsequent slots for TBoMS transmission, DMRS is located in the first symbol of the slot.

Further, for the TBoMS transmission in the first and last slot, position of additional DMRS symbols is determined based on the dmrs-AdditionalPosition and number of symbols in the first and last slot for TBoMS transmission, respectively. For the TBoMS transmission in the slots other than the first and last slot, position of additional DMRS symbols is determined based on the dmrs-AdditionalPosition and assuming full-slot transmission in the slot.

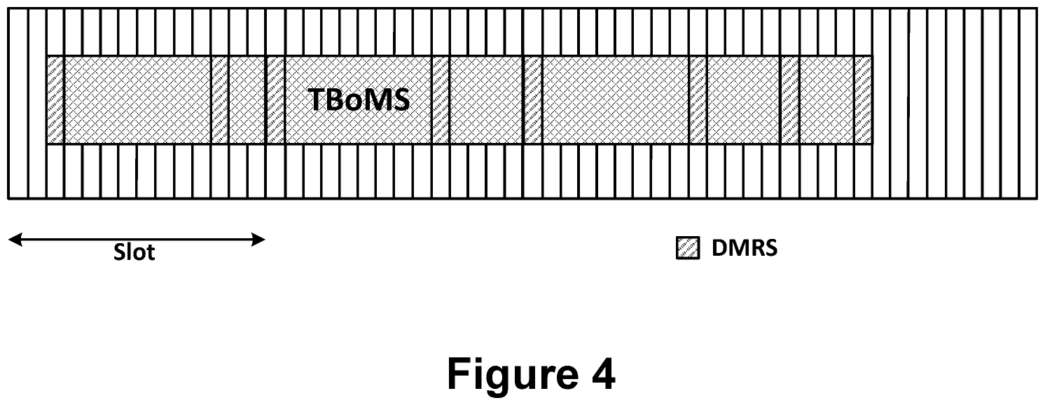

FIG. 4 illustrates one example of DMRS pattern for Type B based TDRA for TBoMS. In the example, TBoMS is allocated with 45 symbols. Further, front loaded DMRSs are allocated for TBoMS transmission in each slot. Further, dmrs-AdditionalPosition is configured with “pos1”, which indicates that in the first slot, symbol #11 is allocated for DMRS symbol, while in the 2^{nd} and 3^{rd} slots, symbol #9 is allocated for DMRS; while in the last symbol, symbol #4 is allocated for DMRS.

In an embodiment, the presence of additional DMRS symbol(s) within a slot duration for TBoMS transmission follows the existing (per 3GPP Release 15/Release 16 specifications) higher layer configuration of presence of additional DMRS symbols as part of DMRS-UplinkConfig. In another embodiment, the presence of additional DMRS can be separately configured for TBoMS and other PUSCH transmissions. In another embodiment, for TBoMS transmissions, additional DMRS symbol(s) are always present within a slot duration.

In an embodiment, the maximum length of the “front-loaded” DMRS symbols (first set of DMRS symbols in each slot of the TBoMS transmission) follows the value of the higher layer parameter maxLength as provided in DMRS-UplinkConfig. Alternatively, the maximum length of the “front-loaded” DMRS symbols (first set of DMRS symbols in each slot of the TBoMS transmission) can be separately configured from that for other PUSCH transmissions.

In an embodiment, for a TBoMS transmission, the position(s) of additional DMRS symbol(s) follow the locations as for other PUSCH transmissions (e.g., as indicated by dmrs-AdditionalPosition in DMRS-UplinkConfig). Alternatively, the position(s) of additional DMRS symbol(s) for TBoMS transmission can be separately configured from that for other PUSCH transmissions.

### Handling Overlapping Between TBoMS and Other Physical Signals/Channels

Embodiments for handling overlapping between TBoMS and other physical signals/channels are provided as follows:

In one embodiment, when type B based mechanism for TDRA is configured or indicated for TBoMS transmission, and if allocated resource in time for TBoMS collides with invalid symbols for PUSCH transmission, then TBoMS is segmented into more than one actual transmission, where each actual transmission includes a consecutive set of all potentially valid symbols for TBoMS transmission. Note that each TBoMS transmission may span across slot boundary or more than one slot. The originally indicated or configured length of the TBoMS transmission in number of symbols is referred to as the nominal duration of the TBoMS. The TB size is determined using at least: the indicated or configured MCS, frequency domain resource allocation (FDRA), and nominal duration of the TBoMS. Further, for Type B based mechanism for TDRA of TBoMS, the rules for determining symbol(s) that may not be available (invalid) for the TBoMS transmission, can be determined following the same rules specified in TS 38.214, Subclause 6.1.2.1 for determination of invalid symbol(s) for PUSCH repetition Type B.

Further, if the number of valid symbols for an actual transmission for TBoMS is 1 symbol, UE omits the actual TBoMS transmission. In another embodiment, if a number of valid symbols for an actual transmission for TBoMS is less than N symbols, where the value of N is specified (e.g., one of 2, 3, 4) or configured via higher layers, UE omits the actual TBoMS transmission in the number of symbols. As another example of the embodiment, the value of N is the number of symbols such that, for the given FDRA and TB size, the effective channel code rate when transmitting over N symbols is not larger than a configured (by higher layers) or specified threshold code rate. In an example, the configured or specified code rate threshold is less than 0.95. In addition, an actual transmission for TBoMS is omitted in accordance with the conditions as defined in Section 11.1 in TS38.213 [1]. Note that for this case, UE determines the transport block size (TBS) in accordance with the allocated resource in time, and same TBS is applied for actual transmission(s) for TBoMS.

Note that the determination of invalid symbol(s) for TBoMS may follow the rule as for PUSCH Type B transmission as defined in Section 6.1.2.1 in TS38.214 [2].

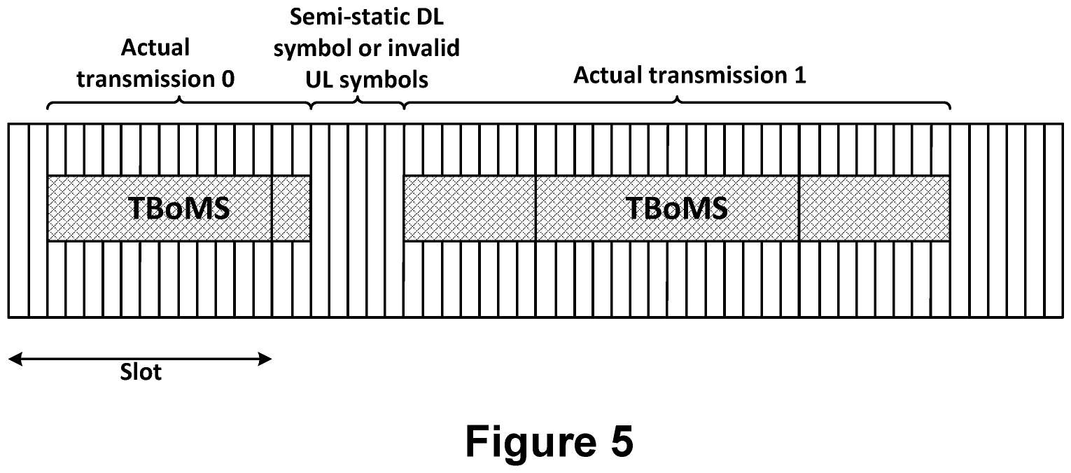

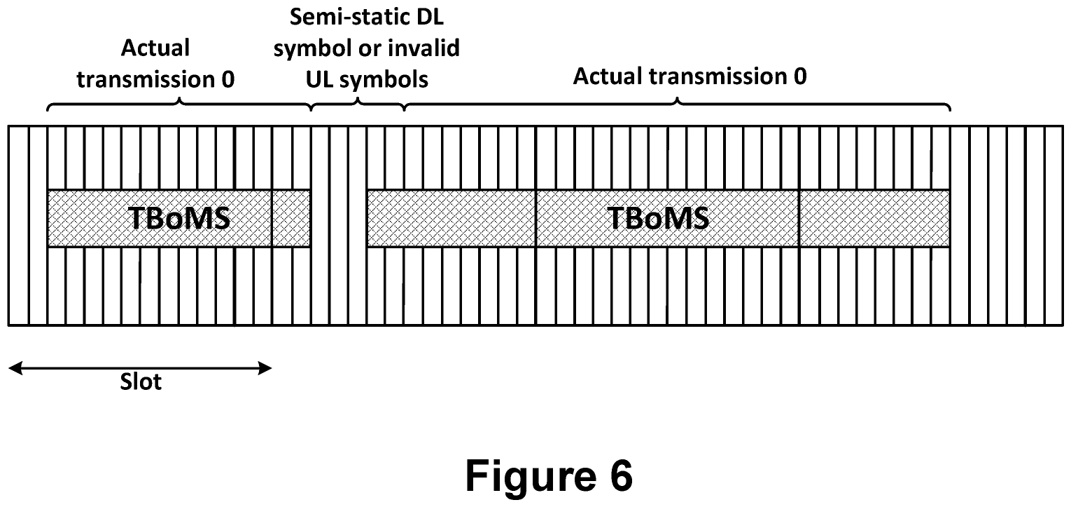

FIG. 5 illustrates one example of handling overlapping between TBoMS and other physical channels/signals when type B based mechanism for TDRA of TBoMS. In the example, TBoMS is allocated with 48 symbols. When allocated TBoMS resource in time collides with semi-static DL symbols and invalid symbols, TBoMS is segmented into two actual transmissions, where each actual transmission may span across slot boundary as for TBoMS. In the example, the first actual TBoMS transmission spans 14 symbols, while the second actual TBoMS transmission spans 29 symbols.

In another embodiment, when a type B based mechanism for TDRA is configured or indicated for TBoMS transmission, and if allocated resource in time for TBoMS collides with invalid symbols for PUSCH transmission, and if the number of consecutive invalid symbols is less than or equal to M symbols, UE shall continue to transmit TBoMS without segmentation. More specifically, M can be configured by higher layers via MSI, RMSI (SIB1), OSI or RRC signalling or predefined in the specification or depends on UE capability on the transmission of TBoMS. In another example, the value of M may be reported by the UE as part of UE capability reporting. In addition, if the number of consecutive invalid symbols is greater than M symbols, then TBoMS is segmented into more than one actual transmission, where each actual transmission includes a consecutive set of all potentially valid symbols for TBoMS transmission.

Further, the TB size is determined using at least: the indicated or configured MCS, frequency domain resource allocation (FDRA), and nominal duration of the TBoMS. In addition, rate-matching or puncturing is performed for the TBoMS transmission when a number of symbols is not used for TBoMS transmission in between as mentioned above. As an alternative to rate-matching or puncturing-based handling of invalid symbols for TBoMS transmission, the TB size determination and mapping of the PUSCH symbols to time-frequency resources are performed by excluding the symbols invalid for TBoMS transmission when the gap is no longer than M symbols. In other words, the nominal duration of the TBoMS is determined by excluding a gap due to invalid symbols within the TBoMS as long as the gap is of length M symbols or less.

Note that the rules for determining symbol(s) that may not be available (invalid) for the TBoMS transmission, can be determined following the same rules specified in TS 38.214, Subclause 6.1.2.1 for determination of invalid symbol(s) for PUSCH repetition Type B.

FIG. 5 illustrates one example of handling overlapping between TBoMS and other physical channels/signals when type B based mechanism for TDRA of TBoMS. In the example, TBoMS is allocated with 48 symbols. Further, the number of invalid symbols is 3, which is less than a predefined threshold, UE continues to transmit TBoMS. In addition, the total number of symbols allocated for this TBoMS transmission is 45.

In another embodiment, one transmission occasion of the TBoMS may span non-continuous slots or symbols. The gap or the number of continuous invalid symbols may be determined in accordance with the semi-static TDD UL/DL configurations, SSB symbols, or the rule for determining symbol(s) that may not be available (invalid) for the TBoMS transmission, can be determined following the same rules specified in TS 38.214, Subclause 6.1.2.1 for determination of invalid symbol(s) for PUSCH repetition Type B.

Further, if the gap is less than or equal to a threshold, UE may assume a single transmission occasions for TBoMS, where a single redundancy version (RV) is applied for the transmission of TBoMS. Further, if the gap is greater than a threshold, UE may segment the TBoMS transmission into multiple transmission occasions or repetitions, where same or different RVs can be applied for each transmission occasion of the TBoMS.

The threshold may be configured by higher layers via minimum system information (MSI), remaining minimum system information (RMSI), other system information (OSI) or dedicated radio resource control (RRC) signalling. This may also depend on UE capability on the gap within a TBoMS transmission or a transmission occasion of the TBoMS.

Note that when multiple gaps or multiple continuous invalid symbols are determined, the maximum gaps or maximum number of continuous invalid symbols can be used to determine the transmission occasions of TBoMS transmission.

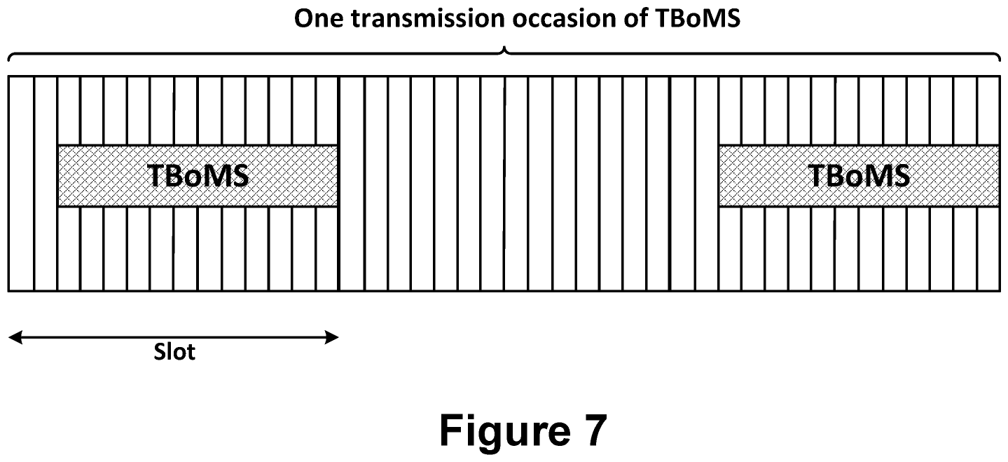

FIG. 7 illustrates one example of single transmission occasion of TBoMS when the gap is less than threshold. In the example, it is assumed the threshold is configured as 2 slots. Based on the TDRA and the semi-static TDD UL/DL configuration, the gap within a TBoMS is 1 slot. Then in this case, single transmission occasion of TBoMS is used, e.g., a single redundancy version (RV) is applied for the transmission of TBoMS in slot #0 and #2.

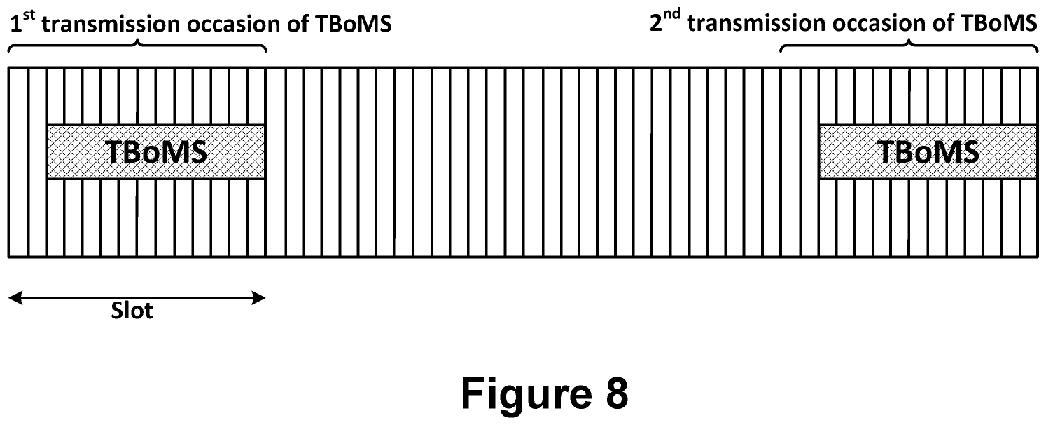

FIG. 8 illustrates one example of multiple transmission occasions of TBoMS when the gap is greater than a threshold. In the example, it is assumed the threshold is configured as 1 slot. Based on the TDRA and the semi-static TDD UL/DL configuration, the gap within a TBoMS is 2 slots. Then in this case, two transmission occasions of TBoMS is used, e.g, first transmission occasion is in the slot #1 and second transmission occasion is in the slot #4.

### Configuration of Overhead for TBS Determination for TBoMS

In NR Rel-15, the number of REs within a PRB for PUSCH transmission is determined as in Section 6.1.4.2 in TS38.214 [2]. More specifically,

N′_{RE}=N_{sc}^{RB}·N_{symb}^{sh}−N_{DMRS}^{PRB}−Nₒₕ^{PRB},

Where Nₒₕ^{PRB} is the overhead configured by higher layer parameter xOverhead in PUSCH-ServingCellConfig. If the Nₒₕ^{PRB} is not configured (a value from 6, 12, or 18), the Nₒₕ^{PRB} is assumed to be 0.

Embodiments of configuration of overhead for TBS determination for TBoMS are provided as follows:

In one embodiment, multiple overhead values can be configured by higher layers via MSI, RMSI (SIB1), OSI or RRC signalling, where each overhead value is associated with a range of number of symbols or slots. In this case, UE first determines number of symbols or slots based on the allocated resource in time and subsequently determines the overhead for TBS determination accordingly.

Table 4 illustrates one example of configuration of overhead for TBoMS. In the example, N_{symb,i}, (i=0,1,2,3) are the thresholds for number of symbols, which can be configured by higher layers via MSI, RMSI (SIB1), OSI or RRC signalling or predefined in the specification. N_{oh,i}^{PRB}, (i=0,1,2) are the configured overheads for TBS determination for TBoMS. N_{symb} is the number of symbols based on the TDRA allocated for TBoMS.

Note that although in the Table 4, number of symbols is used to determine overhead, same design principle can be straightforwardly extended to the case when number of slots is used to determine overhead.

TABLE 4
Configuration of overhead for TBoMS

| Overhead | Number of symbols for TBoMS |
|---|---|
| N_{oh,0}^{PRB} | N_{symb,0} ≤ N_{symb} < N_{symb,1} |
| N_{oh,1}^{PRB} | N_{symb,1} ≤ N_{symb} < N_{symb,2} |
| N_{oh,2}^{PRB} | N_{symb,2} ≤ N_{symb} < N_{symb,3} |

### Systems and Implementations

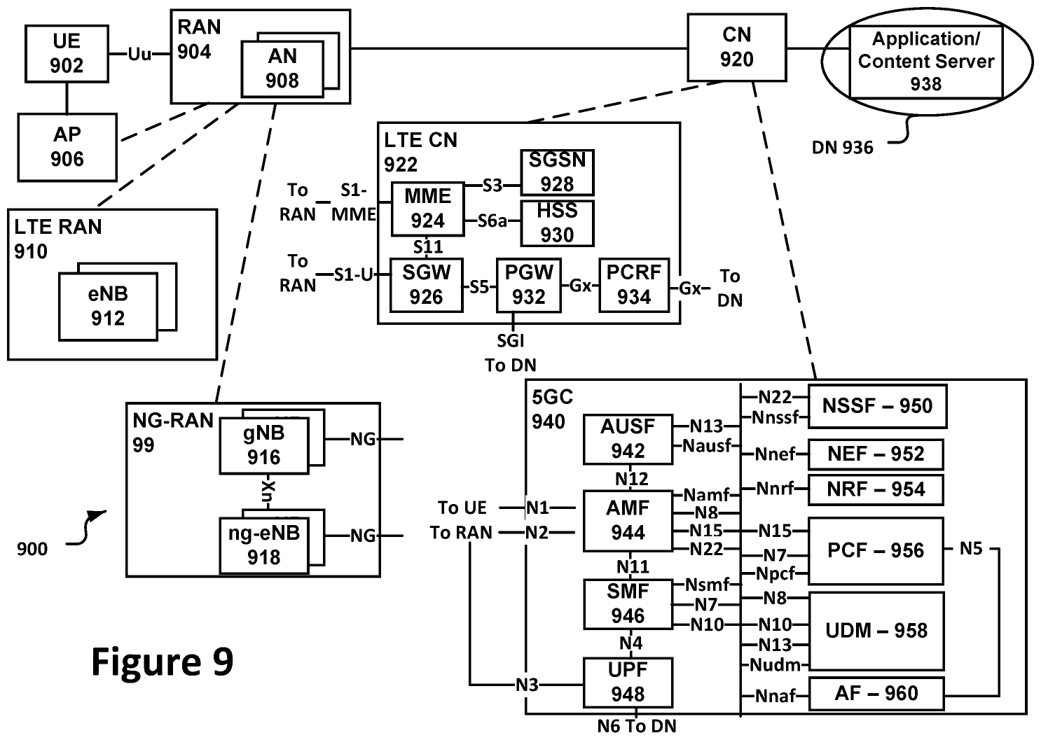

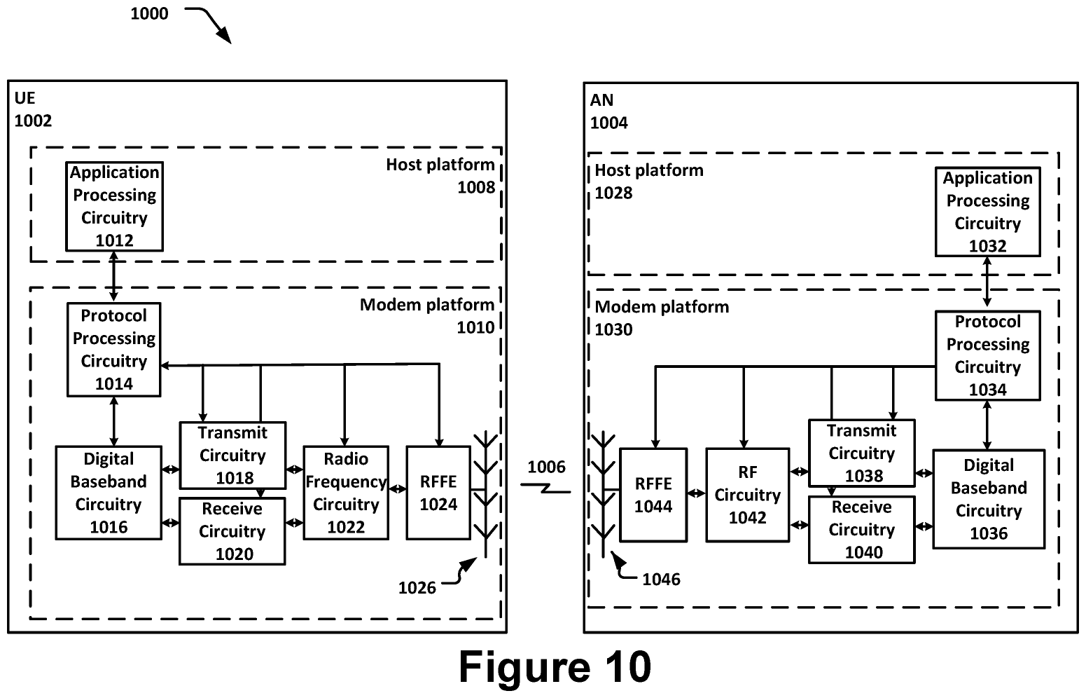

FIGS. 9-10 illustrate various systems, devices, and components that may implement aspects of disclosed embodiments.

FIG. 9 illustrates a network 900 in accordance with various embodiments. The network 900 may operate in a manner consistent with 3GPP technical specifications for LTE or 5G/NR systems. However, the example embodiments are not limited in this regard and the described embodiments may apply to other networks that benefit from the principles described herein, such as future 3GPP systems, or the like.

The network 900 may include a UE 902, which may include any mobile or non-mobile computing device designed to communicate with a RAN 904 via an over-the-air connection. The UE 902 may be communicatively coupled with the RAN 904 by a Uu interface. The UE 902 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

In some embodiments, the network 900 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc.

In some embodiments, the UE 902 may additionally communicate with an AP 906 via an over-the-air connection. The AP 906 may manage a WLAN connection, which may serve to offload some/all network traffic from the RAN 904. The connection between the UE 902 and the AP 906 may be consistent with any IEEE 802.11 protocol, wherein the AP 906 could be a wireless fidelity (Wi-Fi®) router. In some embodiments, the UE 902, RAN 904, and AP 906 may utilize cellular-WLAN aggregation (for example, LWA/LWIP). Cellular-WLAN aggregation may involve the UE 902 being configured by the RAN 904 to utilize both cellular radio resources and WLAN resources.

The RAN 904 may include one or more access nodes, for example, AN 908. AN 908 may terminate air-interface protocols for the UE 902 by providing access stratum protocols including RRC, PDCP, RLC, MAC, and L1 protocols. In this manner, the AN 908 may enable data/voice connectivity between CN 920 and the UE 902. In some embodiments, the AN 908 may be implemented in a discrete device or as one or more software entities running on server computers as part of, for example, a virtual network, which may be referred to as a CRAN or virtual baseband unit pool. The AN 908 be referred to as a BS, gNB, RAN node, eNB, ng-eNB, NodeB, RSU, TRxP, TRP, etc. The AN 908 may be a macrocell base station or a low power base station for providing femtocells, picocells or other like cells having smaller coverage areas, smaller user capacity, or higher bandwidth compared to macrocells.

In embodiments in which the RAN 904 includes a plurality of ANs, they may be coupled with one another via an X2 interface (if the RAN 904 is an LTE RAN) or an Xn interface (if the RAN 904 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 904 may each manage one or more cells, cell groups, component carriers, etc. to provide the UE 902 with an air interface for network access. The UE 902 may be simultaneously connected with a plurality of cells provided by the same or different ANs of the RAN 904. For example, the UE 902 and RAN 904 may use carrier aggregation to allow the UE 902 to connect with a plurality of component carriers, each corresponding to a Pcell or Scell. In dual connectivity scenarios, a first AN may be a master node that provides an MCG and a second AN may be secondary node that provides an SCG. The first/second ANs may be any combination of eNB, gNB, ng-eNB, etc.

The RAN 904 may provide the air interface over a licensed spectrum or an unlicensed spectrum. To operate in the unlicensed spectrum, the nodes may use LAA, eLAA, and/or feLAA mechanisms based on CA technology with PCells/Scells. Prior to accessing the unlicensed spectrum, the nodes may perform medium/carrier-sensing operations based on, for example, a listen-before-talk (LBT) protocol.

In V2X scenarios the UE 902 or AN 908 may be or act as a RSU, which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 904 may be an LTE RAN 910 with eNBs, for example, eNB 912. The LTE RAN 910 may provide an LTE air interface with the following characteristics: SCS of 15 kHz; CP-OFDM waveform for DL and SC-FDMA waveform for UL; turbo codes for data and TBCC for control; etc. The LTE air interface may rely on CSI-RS for CSI acquisition and beam management; PDSCH/PDCCH DMRS for PDSCH/PDCCH demodulation; and CRS for cell search and initial acquisition, channel quality measurements, and channel estimation for coherent demodulation/detection at the UE. The LTE air interface may operating on sub-6 GHz bands.

In some embodiments, the RAN 904 may be an NG-RAN 914 with gNBs, for example, gNB 916, or ng-eNBs, for example, ng-eNB 918. The gNB 916 may connect with 5G-enabled UEs using a 5G NR interface. The gNB 916 may connect with a 5G core through an NG interface, which may include an N2 interface or an N3 interface. The ng-eNB 918 may also connect with the 5G core through an NG interface, but may connect with a UE via an LTE air interface. The gNB 916 and the ng-eNB 918 may connect with each other over an Xn interface.

In some embodiments, the NG interface may be split into two parts, an NG user plane (NG-U) interface, which carries traffic data between the nodes of the NG-RAN 914 and a UPF 948 (e.g., N3 interface), and an NG control plane (NG-C) interface, which is a signaling interface between the nodes of the NG-RAN 914 and an AMF 944 (e.g., N2 interface).

The NG-RAN 914 may provide a 5G-NR air interface with the following characteristics: variable SCS; CP-OFDM for DL, CP-OFDM and DFT-s-OFDM for UL; polar, repetition, simplex, and Reed-Muller codes for control and LDPC for data. The 5G-NR air interface may rely on CSI-RS, PDSCH/PDCCH DMRS similar to the LTE air interface. The 5G-NR air interface may not use a CRS, but may use PBCH DMRS for PBCH demodulation; PTRS for phase tracking for PDSCH; and tracking reference signal for time tracking. The 5G-NR air interface may operating on FR1 bands that include sub-6 GHz bands or FR2 bands that include bands from 24.25 GHz to 52.6 GHz. The 5G-NR air interface may include an SSB that is an area of a downlink resource grid that includes PSS/SSS/PBCH.

In some embodiments, the 5G-NR air interface may utilize BWPs for various purposes. For example, BWP can be used for dynamic adaptation of the SCS. For example, the UE 902 can be configured with multiple BWPs where each BWP configuration has a different SCS. When a BWP change is indicated to the UE 902, the SCS of the transmission is changed as well. Another use case example of BWP is related to power saving. In particular, multiple BWPs can be configured for the UE 902 with different amount of frequency resources (for example, PRBs) to support data transmission under different traffic loading scenarios. A BWP containing a smaller number of PRBs can be used for data transmission with small traffic load while allowing power saving at the UE 902 and in some cases at the gNB 916. A BWP containing a larger number of PRBs can be used for scenarios with higher traffic load.

The RAN 904 is communicatively coupled to CN 920 that includes network elements to provide various functions to support data and telecommunications services to customers/subscribers (for example, users of UE 902). The components of the CN 920 may be implemented in one physical node or separate physical nodes. In some embodiments, NFV may be utilized to virtualize any or all of the functions provided by the network elements of the CN 920 onto physical compute/storage resources in servers, switches, etc. A logical instantiation of the CN 920 may be referred to as a network slice, and a logical instantiation of a portion of the CN 920 may be referred to as a network sub-slice.

In some embodiments, the CN 920 may be an LTE CN 922, which may also be referred to as an EPC. The LTE CN 922 may include MME 924, SGW 926, SGSN 928, HSS 930, PGW 932, and PCRF 934 coupled with one another over interfaces (or “reference points”) as shown. Functions of the elements of the LTE CN 922 may be briefly introduced as follows.

The MME 924 may implement mobility management functions to track a current location of the UE 902 to facilitate paging, bearer activation/deactivation, handovers, gateway selection, authentication, etc.

The SGW 926 may terminate an S1 interface toward the RAN and route data packets between the RAN and the LTE CN 922. The SGW 926 may be a local mobility anchor point for inter-RAN node handovers and also may provide an anchor for inter-3GPP mobility. Other responsibilities may include lawful intercept, charging, and some policy enforcement.

The SGSN 928 may track a location of the UE 902 and perform security functions and access control. In addition, the SGSN 928 may perform inter-EPC node signaling for mobility between different RAT networks; PDN and S-GW selection as specified by MME 924; MME selection for handovers; etc. The S3 reference point between the MME 924 and the SGSN 928 may enable user and bearer information exchange for inter-3GPP access network mobility in idle/active states.

The HSS 930 may include a database for network users, including subscription-related information to support the network entities' handling of communication sessions. The HSS 930 can provide support for routing/roaming, authentication, authorization, naming/addressing resolution, location dependencies, etc. An S6a reference point between the HSS 930 and the MME 924 may enable transfer of subscription and authentication data for authenticating/authorizing user access to the LTE CN 920.

The PGW 932 may terminate an SGi interface toward a data network (DN) 936 that may include an application/content server 938. The PGW 932 may route data packets between the LTE CN 922 and the data network 936. The PGW 932 may be coupled with the SGW 926 by an S5 reference point to facilitate user plane tunneling and tunnel management. The PGW 932 may further include a node for policy enforcement and charging data collection (for example, PCEF). Additionally, the SGi reference point between the PGW 932 and the data network 9 36 may be an operator external public, a private PDN, or an intra-operator packet data network, for example, for provision of IMS services. The PGW 932 may be coupled with a PCRF 934 via a Gx reference point.

The PCRF 934 is the policy and charging control element of the LTE CN 922. The PCRF 934 may be communicatively coupled to the app/content server 938 to determine appropriate QoS and charging parameters for service flows. The PCRF 932 may provision associated rules into a PCEF (via Gx reference point) with appropriate TFT and QCI.

In some embodiments, the CN 920 may be a 5GC 940. The 5GC 940 may include an AUSF 942, AMF 944, SMF 946, UPF 948, NSSF 950, NEF 952, NRF 954, PCF 956, UDM 958, and AF 960 coupled with one another over interfaces (or “reference points”) as shown. Functions of the elements of the 5GC 940 may be briefly introduced as follows.

The AUSF 942 may store data for authentication of UE 902 and handle authentication-related functionality. The AUSF 942 may facilitate a common authentication framework for various access types. In addition to communicating with other elements of the 5GC 940 over reference points as shown, the AUSF 942 may exhibit an Nausf service-based interface.

The AMF 944 may allow other functions of the 5GC 940 to communicate with the UE 902 and the RAN 904 and to subscribe to notifications about mobility events with respect to the UE 902. The AMF 944 may be responsible for registration management (for example, for registering UE 902), connection management, reachability management, mobility management, lawful interception of AMF-related events, and access authentication and authorization. The AMF 944 may provide transport for SM messages between the UE 902 and the SMF 946, and act as a transparent proxy for routing SM messages. AMF 944 may also provide transport for SMS messages between UE 902 and an SMSF. AMF 944 may interact with the AUSF 942 and the UE 902 to perform various security anchor and context management functions. Furthermore, AMF 944 may be a termination point of a RAN CP interface, which may include or be an N2 reference point between the RAN 904 and the AMF 944; and the AMF 944 may be a termination point of NAS (N1) signaling, and perform NAS ciphering and integrity protection. AMF 944 may also support NAS signaling with the UE 902 over an N3 IWF interface.

The SMF 946 may be responsible for SM (for example, session establishment, tunnel management between UPF 948 and AN 908); UE IP address allocation and management (including optional authorization); selection and control of UP function; configuring traffic steering at UPF 948 to route traffic to proper destination; termination of interfaces toward policy control functions; controlling part of policy enforcement, charging, and QoS; lawful intercept (for SM events and interface to LI system); termination of SM parts of NAS messages; downlink data notification; initiating AN specific SM information, sent via AMF 944 over N2 to AN 908; and determining SSC mode of a session. SM may refer to management of a PDU session, and a PDU session or “session” may refer to a PDU connectivity service that provides or enables the exchange of PDUs between the UE 902 and the data network 936.

The UPF 948 may act as an anchor point for intra-RAT and inter-RAT mobility, an external PDU session point of interconnect to data network 936, and a branching point to support multi-homed PDU session. The UPF 948 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., SDF-to-QoS flow mapping), transport level packet marking in the uplink and downlink, and perform downlink packet buffering and downlink data notification triggering. UPF 948 may include an uplink classifier to support routing traffic flows to a data network.

The NSSF 950 may select a set of network slice instances serving the UE 902. The NSSF 950 may also determine allowed NSSAI and the mapping to the subscribed S-NSSAIs, if needed. The NSSF 950 may also determine the AMF set to be used to serve the UE 902, or a list of candidate AMFs based on a suitable configuration and possibly by querying the NRF 954. The selection of a set of network slice instances for the UE 902 may be triggered by the AMF 944 with which the UE 902 is registered by interacting with the NSSF 950, which may lead to a change of AMF. The NSSF 950 may interact with the AMF 944 via an N22 reference point; and may communicate with another NSSF in a visited network via an N31 reference point (not shown). Additionally, the NSSF 950 may exhibit an Nnssf service-based interface.

The NEF 952 may securely expose services and capabilities provided by 3GPP network functions for third party, internal exposure/re-exposure, AFs (e.g., AF 960), edge computing or fog computing systems, etc. In such embodiments, the NEF 952 may authenticate, authorize, or throttle the AFs. NEF 952 may also translate information exchanged with the AF 960 and information exchanged with internal network functions. For example, the NEF 952 may translate between an AF-Service-Identifier and an internal 5GC information. NEF 952 may also receive information from other NFs based on exposed capabilities of other NFs. This information may be stored at the NEF 952 as structured data, or at a data storage NF using standardized interfaces. The stored information can then be re-exposed by the NEF 952 to other NFs and AFs, or used for other purposes such as analytics. Additionally, the NEF 952 may exhibit an Nnef service-based interface.

The NRF 954 may support service discovery functions, receive NF discovery requests from NF instances, and provide the information of the discovered NF instances to the NF instances. NRF 954 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 954 may exhibit the Nnrf service-based interface.

The PCF 956 may provide policy rules to control plane functions to enforce them, and may also support unified policy framework to govern network behavior. The PCF 956 may also implement a front end to access subscription information relevant for policy decisions in a UDR of the UDM 958. In addition to communicating with functions over reference points as shown, the PCF 956 exhibit an Npcf service-based interface.

The UDM 958 may handle subscription-related information to support the network entities' handling of communication sessions, and may store subscription data of UE 902. For example, subscription data may be communicated via an N8 reference point between the UDM 958 and the AMF 944. The UDM 958 may include two parts, an application front end and a UDR. The UDR may store subscription data and policy data for the UDM 958 and the PCF 956, and/or structured data for exposure and application data (including PFDs for application detection, application request information for multiple UEs 902) for the NEF 952. The Nudr service-based interface may be exhibited by the UDR 221 to allow the UDM 958, PCF 956, and NEF 952 to access a particular set of the stored data, as well as to read, update (e.g., add, modify), delete, and subscribe to notification of relevant data changes in the UDR. The UDM may include a UDM-FE, which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 958 may exhibit the Nudm service-based interface.

The AF 960 may provide application influence on traffic routing, provide access to NEF, and interact with the policy framework for policy control.

In some embodiments, the 5GC 940 may enable edge computing by selecting operator/3rd party services to be geographically close to a point that the UE 902 is attached to the network. This may reduce latency and load on the network. To provide edge-computing implementations, the 5GC 940 may select a UPF 948 close to the UE 902 and execute traffic steering from the UPF 948 to data network 936 via the N6 interface. This may be based on the UE subscription data, UE location, and information provided by the AF 960. In this way, the AF 960 may influence UPF (re)selection and traffic routing. Based on operator deployment, when AF 960 is considered to be a trusted entity, the network operator may permit AF 960 to interact directly with relevant NFs. Additionally, the AF 960 may exhibit an Naf service-based interface.

The data network 936 may represent various network operator services, Internet access, or third party services that may be provided by one or more servers including, for example, application/content server 938.

FIG. 10 schematically illustrates a wireless network 1000 in accordance with various embodiments. The wireless network 1000 may include a UE 1002 in wireless communication with an AN 1004. The UE 1002 and AN 1004 may be similar to, and substantially interchangeable with, like-named components described elsewhere herein.

The UE 1002 may be communicatively coupled with the AN 1004 via connection 1006. The connection 1006 is illustrated as an air interface to enable communicative coupling, and can be consistent with cellular communications protocols such as an LTE protocol or a 5G NR protocol operating at mmWave or sub-6 GHz frequencies.

The UE 1002 may include a host platform 1008 coupled with a modem platform 1010. The host platform 1008 may include application processing circuitry 1012, which may be coupled with protocol processing circuitry 1014 of the modem platform 1010. The application processing circuitry 1012 may run various applications for the UE 1002 that source/sink application data. The application processing circuitry 1012 may further implement one or more layer operations to transmit/receive application data to/from a data network. These layer operations may include transport (for example UDP) and Internet (for example, IP) operations

The protocol processing circuitry 1014 may implement one or more of layer operations to facilitate transmission or reception of data over the connection 1006. The layer operations implemented by the protocol processing circuitry 1014 may include, for example, MAC, RLC, PDCP, RRC and NAS operations.

The modem platform 1010 may further include digital baseband circuitry 1016 that may implement one or more layer operations that are “below” layer operations performed by the protocol processing circuitry 1014 in a network protocol stack. These operations may include, for example, PHY operations including one or more of HARQ-ACK functions, scrambling/descrambling, encoding/decoding, layer mapping/de-mapping, modulation symbol mapping, received symbol/bit metric determination, multi-antenna port precoding/decoding, which may include one or more of space-time, space-frequency or spatial coding, reference signal generation/detection, preamble sequence generation and/or decoding, synchronization sequence generation/detection, control channel signal blind decoding, and other related functions.

The modem platform 1010 may further include transmit circuitry 1018, receive circuitry 1020, RF circuitry 1022, and RF front end (RFFE) 1024, which may include or connect to one or more antenna panels 1026. Briefly, the transmit circuitry 1018 may include a digital-to-analog converter, mixer, intermediate frequency (IF) components, etc.; the receive circuitry 1020 may include an analog-to-digital converter, mixer, IF components, etc.; the RF circuitry 1022 may include a low-noise amplifier, a power amplifier, power tracking components, etc.; RFFE 1024 may include filters (for example, surface/bulk acoustic wave filters), switches, antenna tuners, beamforming components (for example, phase-array antenna components), etc. The selection and arrangement of the components of the transmit circuitry 1018, receive circuitry 1020, RF circuitry 1022, RFFE 1024, and antenna panels 1026 (referred generically as “transmit/receive components”) may be specific to details of a specific implementation such as, for example, whether communication is TDM or FDM, in mmWave or sub-6 gHz frequencies, etc. In some embodiments, the transmit/receive components may be arranged in multiple parallel transmit/receive chains, may be disposed in the same or different chips/modules, etc.

In some embodiments, the protocol processing circuitry 1014 may include one or more instances of control circuitry (not shown) to provide control functions for the transmit/receive components.

A UE reception may be established by and via the antenna panels 1026, RFFE 1024, RF circuitry 1022, receive circuitry 1020, digital baseband circuitry 1016, and protocol processing circuitry 1014. In some embodiments, the antenna panels 1026 may receive a transmission from the AN 1004 by receive-beamforming signals received by a plurality of antennas/antenna elements of the one or more antenna panels 1026.

A UE transmission may be established by and via the protocol processing circuitry 1014, digital baseband circuitry 1016, transmit circuitry 1018, RF circuitry 1022, RFFE 1024, and antenna panels 1026. In some embodiments, the transmit components of the UE 1004 may apply a spatial filter to the data to be transmitted to form a transmit beam emitted by the antenna elements of the antenna panels 1026.

Similar to the UE 1002, the AN 1004 may include a host platform 1028 coupled with a modem platform 1030. The host platform 1028 may include application processing circuitry 1032 coupled with protocol processing circuitry 1034 of the modem platform 1030. The modem platform may further include digital baseband circuitry 1036, transmit circuitry 1038, receive circuitry 1040, RF circuitry 1042, RFFE circuitry 1044, and antenna panels 1046. The components of the AN 1004 may be similar to and substantially interchangeable with like-named components of the UE 1002. In addition to performing data transmission/reception as described above, the components of the AN 1008 may perform various logical functions that include, for example, RNC functions such as radio bearer management, uplink and downlink dynamic radio resource management, and data packet scheduling.

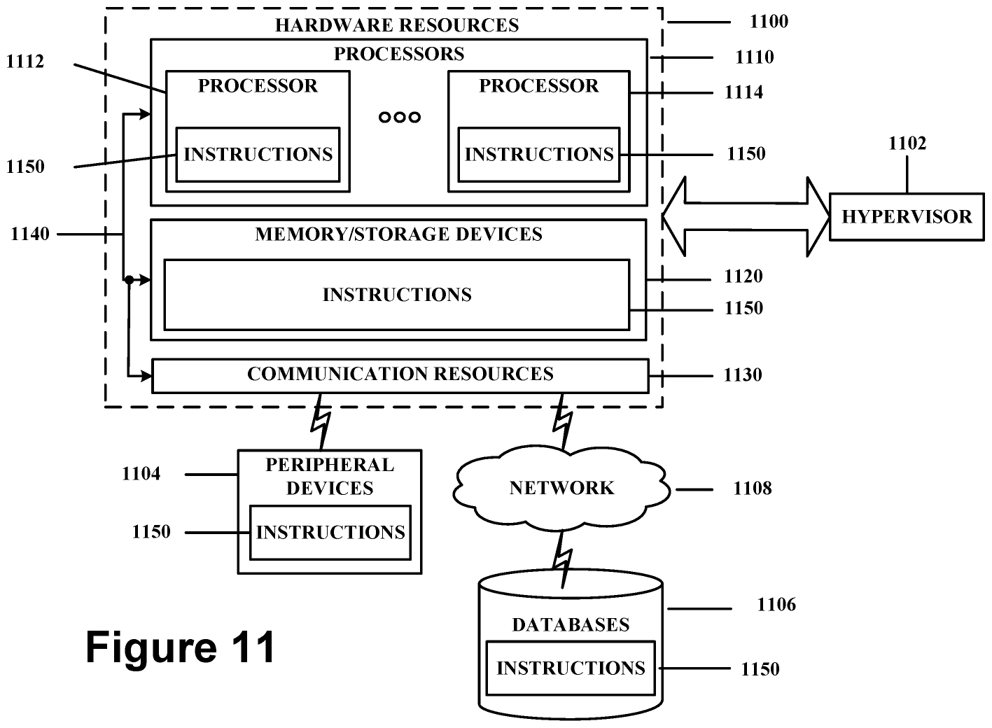

FIG. 11 is a block diagram illustrating components, according to some example embodiments, able to read instructions from a machine-readable or computer-readable medium (e.g., a non-transitory machine-readable storage medium) and perform any one or more of the methodologies discussed herein. Specifically, FIG. 11 shows a diagrammatic representation of hardware resources 1100 including one or more processors (or processor cores) 1110, one or more memory/storage devices 1120, and one or more communication resources 1130, each of which may be communicatively coupled via a bus 1140 or other interface circuitry. For embodiments where node virtualization (e.g., NFV) is utilized, a hypervisor 1102 may be executed to provide an execution environment for one or more network slices/sub-slices to utilize the hardware resources 1100.

The processors 1110 may include, for example, a processor 1112 and a processor 1114. The processors 1110 may be, for example, a central processing unit (CPU), a reduced instruction set computing (RISC) processor, a complex instruction set computing (CISC) processor, a graphics processing unit (GPU), a DSP such as a baseband processor, an ASIC, an FPGA, a radiofrequency integrated circuit (RFIC), another processor (including those discussed herein), or any suitable combination thereof.

The memory/storage devices 1120 may include main memory, disk storage, or any suitable combination thereof. The memory/storage devices 1120 may include, but are not limited to, any type of volatile, non-volatile, or semi-volatile memory such as dynamic random access memory (DRAM), static random access memory (SRAM), erasable programmable read-only memory (EPROM), electrically erasable programmable read-only memory (EEPROM), Flash memory, solid-state storage, etc.

The communication resources 1130 may include interconnection or network interface controllers, components, or other suitable devices to communicate with one or more peripheral devices 1104 or one or more databases 1106 or other network elements via a network 1108. For example, the communication resources 1130 may include wired communication components (e.g., for coupling via USB, Ethernet, etc.), cellular communication components, NFC components, Bluetooth® (or Bluetooth® Low Energy) components, Wi-Fi® components, and other communication components.

Instructions 1150 may comprise software, a program, an application, an applet, an app, or other executable code for causing at least any of the processors 1110 to perform any one or more of the methodologies discussed herein. The instructions 1150 may reside, completely or partially, within at least one of the processors 1110 (e.g., within the processor's cache memory), the memory/storage devices 1120, or any suitable combination thereof. Furthermore, any portion of the instructions 1150 may be transferred to the hardware resources 1100 from any combination of the peripheral devices 1104 or the databases 1106. Accordingly, the memory of processors 1110, the memory/storage devices 1120, the peripheral devices 1104, and the databases 1106 are examples of computer-readable and machine-readable media.

### Example Procedures

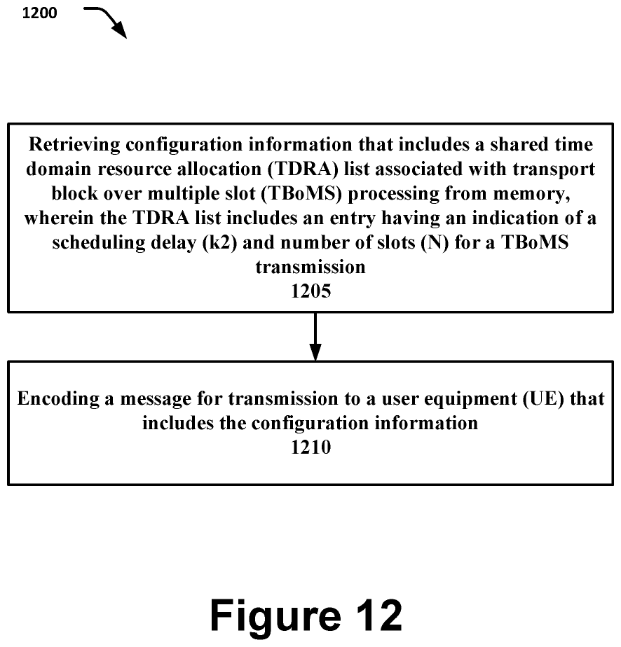

In some embodiments, the electronic device(s), network(s), system(s), chip(s) or component(s), or portions or implementations thereof, of FIGS. 9-11, or some other figure herein, may be configured to perform one or more processes, techniques, or methods as described herein, or portions thereof. One such process is depicted in FIG. 12. For example, process 1200 may include, at 1205, retrieving configuration information that includes a shared time domain resource allocation (TDRA) list associated with transport block over multiple slot (TBoMS) processing from memory, wherein the TDRA list includes an entry having an indication of a scheduling delay (k2) and number of slots (N) for a TBoMS transmission. The process further includes, at 1210, encoding a message for transmission to a user equipment (UE) that includes the configuration information.

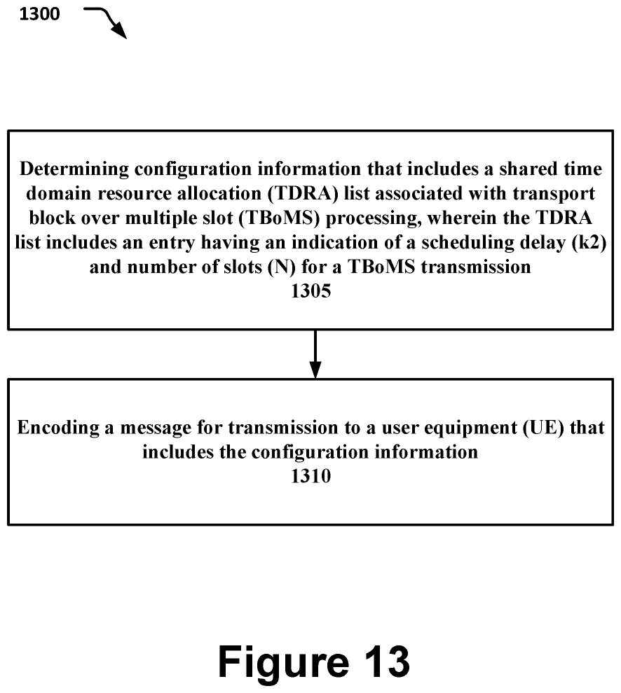

Another such process is illustrated in FIG. 13. In this example, the process 1300 includes, at 1305, determining configuration information that includes a shared time domain resource allocation (TDRA) list associated with transport block over multiple slot (TBoMS) processing, wherein the TDRA list includes an entry having an indication of a scheduling delay (k2) and number of slots (N) for a TBoMS transmission. The process further includes, at 1310, encoding a message for transmission to a user equipment (UE) that includes the configuration information.

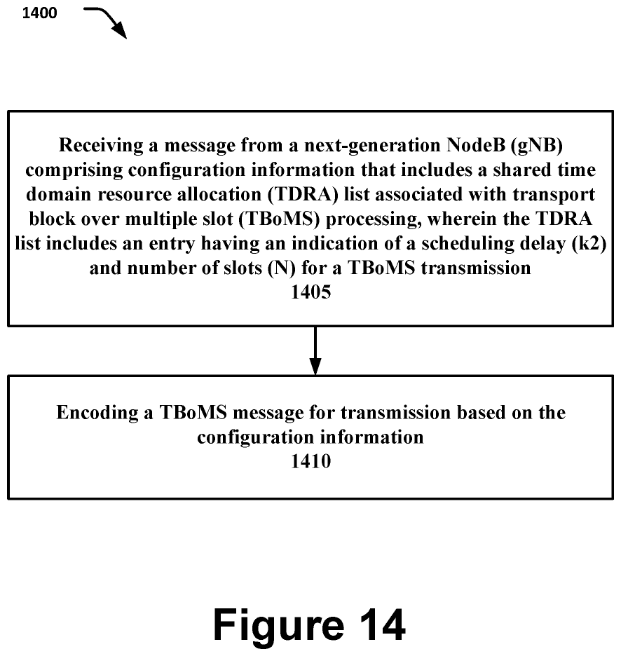

Another such process is illustrated in FIG. 14. In this example, the process 1400 includes, at 1405, receiving a message from a next-generation NodeB (gNB) comprising configuration information that includes a shared time domain resource allocation (TDRA) list associated with transport block over multiple slot (TBoMS) processing, wherein the TDRA list includes an entry having an indication of a scheduling delay (k2) and number of slots (N) for a TBoMS transmission. The process further includes, at 1410, encoding a TBoMS message for transmission based on the configuration information.

For one or more embodiments, at least one of the components set forth in one or more of the preceding figures may be configured to perform one or more operations, techniques, processes, and/or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

Example 1 may include a method of wireless communication for a fifth generation (5G) or new radio (NR) system, the method comprising:
indicating, by a next-generation NodeB (gNB), an indication on whether repetition type A or repetition type B based mechanism is used for transport block (TB) over multi-slot (TBoMS) on physical uplink shared channel (PUSCH); and
transmitting, by a user equipment (UE), the TBoMS on PUSCH in accordance with the indication.

Example 2 may include the method of example 1 or some other example herein, wherein an indication to indicate whether repetition type A or repetition type B based mechanism is used for TBoMS can be configured by higher layers via minimum system information (MSI), remaining minimum system information (RMSI), other system information (OSI) or dedicated radio resource control (RRC) signalling or dynamically indicated in the downlink control information (DCI) or a combination thereof.

Example 3 may include the method of example 1 or some other example herein, wherein the TDRA for TBoMS can be indicated following currently specified SLIV mechanism for TDRA, wherein the starting symbol S relative to the start of the slot, and the number of consecutive symbols L counting from the symbol S allocated for the PUSCH are determined from the start and length indicator SLIV of the indexed row

Example 4 may include the method of example 1 or some other example herein, wherein if a UE is configured to support both type A and type B based mechanisms for TDRA of TBoMS, a subset of TDRA lists can be configured for either type A or type B based TDRA for TBoMS.

Example 5 may include the method of example 1 or some other example herein, wherein When a UE is scheduled with an entry of the configured TDRA subset, UE can implicitly derive whether type A or type B based mechanism is used.

Example 6 may include the method of example 1 or some other example herein, wherein one bit indication can be included in the DCI to indicate whether to apply type A or type B based mechanism for TDRA of TBoMS.

Example 7 may include the method of example 1 or some other example herein, wherein existing fields in the DCI may be re-purposed to indicate whether to apply repetition type A or repetition type B based mechanism for TDRA of TBoMS.

Example 8 may include the method of example 1 or some other example herein, wherein indication whether to apply type A or type B based mechanism for TDRA of TBoMS can be configured by higher layers via MSI, RMSI (SIB1), OSI or RRC signalling per DCI format.

Example 9 may include the method of example 1 or some other example herein, wherein the TDRA mapping type for TBoMS is implicitly determined by the UE based on the indicated TDRA.

Example 10 may include the method of example 1 or some other example herein, wherein uniformly distributed DMRS symbols can be employed for the TBoMS transmission with Type B based TDRA; wherein the distance between first symbol of front-loaded DMRS symbol(s) and additional symbol(s), as well as between additional symbol(s) can be configured by higher layers via MSI, RMSI (SIB1), OSI or RRC signalling or dynamically indicated in the DCI or a combination thereof.

Example 11 may include the method of example 1 or some other example herein, wherein UE may be provided with a number of DMRS symbols that are then equally-distributed-in-time over the TBoMS duration such that the first DMRS location is in the first symbol of the TBoMS

Example 12 may include the method of example 1 or some other example herein, wherein when type B based TDRA mechanism is used for TBoMS, for the TBoMS transmission in the first slot, front loaded DMRS or DMRS in the first symbol of TBoMS transmission is employed, wherein for the subsequent slots for TBoMS transmission, DMRS is located in the first symbol of the slot.

Example 13 may include the method of example 1 or some other example herein, wherein when type B based mechanism for TDRA is configured or indicated for TBoMS transmission, and if allocated resource in time for TBoMS collides with invalid symbols for PUSCH transmission, then TBoMS is segmented into more than one actual transmission, where each actual transmission includes a consecutive set of all potentially valid symbols for TBoMS transmission

Example 14 may include the method of example 1 or some other example herein, wherein the TB size is determined using at least: the indicated or configured MCS, frequency domain resource allocation (FDRA), and nominal duration of the TBoMS.

Example 15 may include the method of example 1 or some other example herein, wherein if a number of valid symbols for an actual transmission for TBoMS is less than N symbols, where the value of N is specified (e.g., one of 2, 3, 4) or configured via higher layers, UE omits the actual TBoMS transmission in the number of symbols

Example 16 may include the method of example 1 or some other example herein, wherein when type B based mechanism for TDRA is configured or indicated for TBoMS transmission, and if allocated resource in time for TBoMS collides with invalid symbols for PUSCH transmission, and if the number of consecutive invalid symbols is less than or equal to M symbols, UE shall continue to transmit TBoMS without segmentation.

Example 17 may include the method of example 1 or some other example herein, wherein M can be configured by higher layers via MSI, RMSI (SIB1), OSI or RRC signalling or predefined in the specification or depends on UE capability on the transmission of TBoMS.

Example 18 may include the method of example 1 or some other example herein, wherein if the number of consecutive invalid symbols is greater than M symbols, then TBoMS is segmented into more than one actual transmission, where each actual transmission includes a consecutive set of all potentially valid symbols for TBoMS transmission.

Example 19 may include the method of example 1 or some other example herein, wherein rate-matching or puncturing is performed for the TBoMS transmission when a number of symbols is not used for TBoMS transmission in between as mentioned above

Example 20 may include the method of example 1 or some other example herein, wherein the nominal duration of the TBoMS is determined by excluding a gap due to invalid symbols within the TBoMS as long as the gap is of length M symbols or less.

Example 21 may include the method of example 1 or some other example herein, wherein multiple overhead values can be configured by higher layers via MSI, RMSI (SIB1), OSI or RRC signaling, where each overhead value is associated with a range of number of symbols or slots.

Example 22 includes the method of example 1 or some other example herein, wherein the UE first determines number of symbols or slots based on the allocated resource in time and subsequently determines the overhead for TBS determination accordingly.

Example 23 may include the method of example 1 or some other example herein, wherein if the gap is less than or equal to a threshold, UE may assume a single transmission occasions for TBoMS, where a single redundancy version (RV) is applied for the transmission of TBoMS; wherein if the gap is greater than a threshold, UE may segment the TBoMS transmission into multiple transmission occasions or repetitions, where same or different RVs can be applied for each transmission occasion of the TBoMS.

Example 24 may include the method of example 1 or some other example herein, wherein the threshold may be configured by higher layers via minimum system information (MSI), remaining minimum system information (RMSI), other system information (OSI) or dedicated radio resource control (RRC) signaling.

Example 25 may include the method of example 1 or some other example, wherein a shared TDRA table can be configured for both TBoMS and single-slot PUSCH transmission with or without repetitions, wherein for the subset of TDRA list for TBoMS, number of slots for a single TBoMS transmission (N), number of repetitions (M), k2, SLIV and mapping type are configured in each row of the TDRA table for TBoMS.

Example 26 may include the method of example 1 or some other example herein, wherein based on the TDRA list partitioning, e.g, when a UE is configured or scheduled with an entry of the configured TDRA subset, UE can implicitly derive whether TBoMS or single-slot PUSCH transmission is used.

Example 27 may include the method of example 1 or some other example herein, wherein one bit indication can be included as part of TDRA information in each row.

Example 28 may include the method of example 1 or some other example herein, wherein separate TDRA tables can be configured for TBoMS and single-slot PUSCH transmission with or without repetitions, respectively.

Example 29 may include the method of example 1 or some other example herein, wherein number of slots for a single TBoMS transmission or N=1 may be configured in one or more rows of TDRA table to indicate single-slot PUSCH transmission with or without repetitions.

Example 30 includes a method comprising:
determining, by a next-generation NodeB (gNB), configuration information that includes an indication of whether repetition type A or repetition type B based mechanism is used for transport block over multi-slot (TBoMS) on a physical uplink shared channel (PUSCH) by a user equipment (UE); and
encoding a message for transmission to the UE that includes the configuration information.

Example 31 includes the method of example 30 or some other example herein, wherein the message is a minimum system information (MSI) message, remaining minimum system information (RMSI) message, other system information (OSI) message, radio resource control (RRC) message, or downlink control information (DCI) message.

Example 32 includes the method of example 30 or some other example herein, wherein the configuration information further includes an indication of a time domain resource assignment (TDRA) for the TBoMS.

Example 33 includes the method of example 30 or some other example herein, wherein the TBoMS spans non-continuous slots or symbols.

Example 34 includes the method of example 33 or some other example herein, wherein a gap or number of continuous invalid symbols is determined based on a semi-static time division duplexing (TDD) uplink (UL) or downlink (DL) configuration.

Example 35 includes the method of example 34 or some other example herein, wherein the gap is less than or equal to a threshold associated with a single transmission occasion for TBoMS.

Example 36 includes the method of example 35 or some other example herein, wherein the threshold is two slots.

Example 37 includes the method of example 30 or some other example herein, wherein determining the configuration information includes determining a time domain resource allocation (TDRA) table configured for TBoMS or a single-slot PUSCH transmission with or without repetitions.

Example 38 includes the method of example 37 or some other example herein, wherein the TDRA table includes an indication, for a subset of a TDRA list for TBoMS, of a number of slots for a single TBoMS transmission (N), number of repetitions (M), k2, SLIV and mapping type.

Example 39 includes the method of example 38 or some other example herein, wherein the TDRA table is to indicate when a UE is configured or scheduled with an entry of the configured TDRA subset, and to indicate to the UE whether TBoMS or single-slot PUSCH transmission is used.

Example 40 may include the method of example 38 or some other example herein, wherein a one bit indication is included as part of TDRA information in the TDRA table.

Example 41 may include the method of example 30 or some other example herein, wherein determining the configuration information includes determining separate TDRA tables configured for TBoMS and single-slot PUSCH transmission with or without repetitions, respectively.

Example 42 may include the method of example 30 or some other example herein, wherein a number of slots for a single TBoMS transmission or N=1 is indicated in the TDRA table to indicate single-slot PUSCH transmission with or without repetitions.

Example X1 includes an apparatus comprising:
memory to store configuration information that includes a shared time domain resource allocation (TDRA) list associated with transport block over multiple slot (TBoMS) processing; and
processing circuitry, coupled with the memory, to:
   retrieve the configuration information from the memory, wherein the TDRA list includes an entry having an indication of a scheduling delay (k2) and number of slots (N) for a TBoMS transmission; and
   encode a message for transmission to a user equipment (UE) that includes the configuration information.

Example X2 includes the apparatus of example X1 or some other example herein, wherein the entry further includes an indication of a number of repetitions (M) for the TBoMS transmission.

Example X3 includes the apparatus of example X2 or some other example herein, wherein N=1 in the entry to indicate M is to be re-interpreted and applied by the UE for a single-slot physical uplink shared channel (PUSCH) transmission.

Example X4 includes the apparatus of example X3 or some other example herein, wherein the entry further includes an indication that M is to be re-interpreted and applied by the UE for a single-slot physical uplink shared channel (PUSCH) transmission with repetitions.

Example X5 includes the apparatus of any of examples X1-X4, wherein the entry in the TDRA list includes: an indication of a start and length indicator value (SLIV) for the TBoMS transmission, or an indication of a mapping type for the TBoMS transmission.

Example X6 includes one or more computer-readable media storing instructions that, when executed by one or more processors, cause a next-generation NodeB (gNB) to:
determine configuration information that includes a shared time domain resource allocation (TDRA) list associated with transport block over multiple slot (TBoMS) processing, wherein the TDRA list includes an entry having an indication of a scheduling delay (k2) and number of slots (N) for a TBoMS transmission; and
encode a message for transmission to a user equipment (UE) that includes the configuration information.

Example X7 includes the one or more computer-readable media of example X6 or some other example herein, wherein the entry further includes an indication of a number of repetitions (M) for the TBoMS transmission.

Example X8 includes the one or more computer-readable media of example X7 or some other example herein, wherein N=1 in the entry to indicate M is to be re-interpreted and applied by the UE for a single-slot physical uplink shared channel (PUSCH) transmission.

Example X9 includes the one or more computer-readable media of example X8 or some other example herein, wherein the entry further includes an indication that M is to be re-interpreted and applied by the UE for a single-slot physical uplink shared channel (PUSCH) transmission with repetitions.

Example X10 includes the one or more computer-readable media of any of examples X6-X9 or some other example herein, wherein the entry in the TDRA list includes: an indication of a start and length indicator value (SLIV) for the TBoMS transmission, or an indication of a mapping type for the TBoMS transmission.

Example X11 includes one or more computer-readable media storing instructions that, when executed by one or more processors, cause a user equipment (UE) to:
receive a message from a next-generation NodeB (gNB) comprising configuration information that includes a shared time domain resource allocation (TDRA) list associated with transport block over multiple slot (TBoMS) processing, wherein the TDRA list includes an entry having an indication of a scheduling delay (k2) and number of slots (N) for a TBoMS transmission; and
encode a TBoMS message for transmission based on the configuration information.

Example X12 includes the one or more computer-readable media of example X11 or some other example herein, wherein the entry further includes an indication of a number of repetitions (M) for the TBoMS transmission.

Example X13 includes the one or more computer-readable media of example X12 or some other example herein, wherein N=1 in the entry to indicate M is to be re-interpreted and applied by the UE for a single-slot physical uplink shared channel (PUSCH) transmission.

Example X14 includes the one or more computer-readable media of example X13 or some other example herein, wherein the entry further includes an indication that M is to be re-interpreted and applied by the UE for a single-slot physical uplink shared channel (PUSCH) transmission with repetitions.

Example X15 includes the one or more computer-readable media of any of examples X1-X14 or some other example herein, wherein the entry in the TDRA list includes: an indication of a start and length indicator value (SLIV) for the TBoMS transmission, or an indication of a mapping type for the TBoMS transmission.

Example Z01 may include an apparatus comprising means to perform one or more elements of a method described in or related to any of examples 1-X15, or any other method or process described herein.

Example Z02 may include one or more non-transitory computer-readable media comprising instructions to cause an electronic device, upon execution of the instructions by one or more processors of the electronic device, to perform one or more elements of a method described in or related to any of examples 1-X15, or any other method or process described herein.

Example Z03 may include an apparatus comprising logic, modules, or circuitry to perform one or more elements of a method described in or related to any of examples 1-X15, or any other method or process described herein.

Example Z04 may include a method, technique, or process as described in or related to any of examples 1-X15, or portions or parts thereof.

Example Z05 may include an apparatus comprising: one or more processors and one or more computer-readable media comprising instructions that, when executed by the one or more processors, cause the one or more processors to perform the method, techniques, or process as described in or related to any of examples 1-X15, or portions thereof.

Example Z06 may include a signal as described in or related to any of examples 1-X15, or portions or parts thereof.

Example Z07 may include a datagram, packet, frame, segment, protocol data unit (PDU), or message as described in or related to any of examples 1-X15, or portions or parts thereof, or otherwise described in the present disclosure.

Example Z08 may include a signal encoded with data as described in or related to any of examples 1-X15, or portions or parts thereof, or otherwise described in the present disclosure.

Example Z09 may include a signal encoded with a datagram, packet, frame, segment, protocol data unit (PDU), or message as described in or related to any of examples 1-X15, or portions or parts thereof, or otherwise described in the present disclosure.

Example Z10 may include an electromagnetic signal carrying computer-readable instructions, wherein execution of the computer-readable instructions by one or more processors is to cause the one or more processors to perform the method, techniques, or process as described in or related to any of examples 1-X15, or portions thereof.

Example Z11 may include a computer program comprising instructions, wherein execution of the program by a processing element is to cause the processing element to carry out the method, techniques, or process as described in or related to any of examples 1-X15, or portions thereof.

Example Z12 may include a signal in a wireless network as shown and described herein.

Example Z13 may include a method of communicating in a wireless network as shown and described herein.

Example Z14 may include a system for providing wireless communication as shown and described herein.

Example Z15 may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

### Abbreviations

Unless used differently herein, terms, definitions, and abbreviations may be consistent with terms, definitions, and abbreviations defined in 3GPP TR 21.905 v16.0.0 (2019 June). For the purposes of the present document, the following abbreviations may apply to the examples and embodiments discussed herein.

| | |
|---|---|
| 3GPP | Third Generation |
| | Partnership Project |
| 4G | Fourth Generation |
| 5G | Fifth Generation |
| 5GC | 5G Core network |
| AC | Application Client |
| ACK | Acknowledgement |
| ACID | Application |
| | Client Identification |
| AF | Application Function |
| AM | Acknowledged Mode |
| AMBR | Aggregate |
| | Maximum Bit Rate |
| AMF | Access and Mobility |
| | Management Function |
| AN | Access Network |
| ANR | Automatic |
| | Neighbour Relation |
| AP | Application |
| | Protocol, Antenna |
| | Port, Access Point |
| API | Application |
| | Programming Interface |
| APN | Access Point Name |
| ARP | Allocation and |
| | Retention Priority |
| ARQ | Automatic |
| | Repeat Request |
| AS | Access Stratum |
| ASP | Application Service |
| | Provider |
| ASN.1 | Abstract Syntax |
| | Notation One |
| AUSF | Authentication |
| | Server Function |
| AWGN | Additive White |
| | Gaussian Noise |
| BAP | Backhaul |
| | Adaptation Protocol |
| BCH | Broadcast Channel |
| BER | Bit Error Ratio |
| BFD | Beam |
| | Failure Detection |
| BLER | Block Error Rate |
| BPSK | Binary Phase Shift |
| | Keying |
| BRAS | Broadband Remote |
| | Access Server |
| BSS | Business Support |
| | System |
| BS | Base Station |
| BSR | Buffer Status Report |
| BW | Bandwidth |
| BWP | Bandwidth Part |
| C-RNTI | Cell Radio Network |
| | Temporary Identity |
| CA | Carrier Aggregation, |
| | Certification Authority |
| CAPEX | CAPital EXpenditure |
| CBRA | Contention Based |
| | Random Access |
| CC | Component |
| | Carrier, Country |
| | Code, Cryptographic |
| | Checksum |
| CCA | Clear Channel |
| | Assessment |
| CCE | Control Channel |
| | Element |
| CCCH | Common |
| | Control Channel |
| CE | Coverage |
| | Enhancement |
| CDM | Content Delivery |
| | Network |
| CDMA | Code-Division |
| | Multiple Access |
| CFRA | Contention Free |
| | Random Access |
| CG | Cell Group |
| CGF | Charging |
| | Gateway Function |
| CHF | Charging Function |
| CI | Cell Identity |
| CID | Cell-ID (e.g., |
| | positioning method) |
| CIM | Common |
| | Information Model |
| CIR | Carrier to |
| | Interference Ratio |
| CK | Cipher Key |
| CM | Connection |
| | Management, |
| | Conditional |
| | Mandatory |
| CMAS | Commercial |
| | Mobile Alert Service |
| CMD | Command |
| CMS | Cloud |
| | Management System |
| CO | Conditional Optional |
| CoMP | Coordinated |
| | Multi-Point |
| CORESET | Control |
| | Resource Set |
| COTS | Commercial Off- |
| | The-Shelf |
| CP | Control Plane, |
| | Cyclic Prefix, |
| | Connection Point |
| CPD | Connection |
| | Point Descriptor |
| CPE | Customer Premise |
| | Equipment |
| CPICH | Common Pilot |
| | Channel |
| CQI | Channel Quality |
| | Indicator |
| CPU | CSI processing |
| | unit, Central |
| | Processing Unit |
| C/R | Command/Response |
| | field bit |
| CRAN | Cloud Radio |
| | Access Network, |
| | Cloud RAN |
| CRB | Common |
| | Resource Block |
| CRC | Cyclic |
| | Redundancy Check |
| CRI | Channel-State |
| | Information Resource |
| | Indicator, CSI-RS |
| | Resource Indicator |
| C-RNTI | Cell RNTI |
| CS | Circuit Switched |
| CSCF | call session |
| | control function |
| CSAR | Cloud Service |
| | Archive |
| CSI | Channel-State |
| | Information |
| CSI-IM | CSI Interference |
| | Measurement |
| CSI-RS | CSI Reference Signal |
| CSI-RSRP | CSI reference signal |
| | received power |
| CSI-RSRQ | CSI reference signal |
| | received quality |
| CSI-SINR | CSI |
| | signal-to-noise and |
| | interference ratio |
| CSMA | Carrier Sense |
| | Multiple Access |
| CSMA/CA | CSMA with collision |
| | avoidance |
| CSS | Common Search |
| | Space, Cell-specific |
| | Search Space |
| CTF | Charging |
| | Trigger Function |
| CTS | Clear-to-Send |
| CW | Codeword |
| CWS | Contention |
| | Window Size |
| D2D | Device-to-Device |
| DC | Dual Connectivity, |
| | Direct Current |
| DCI | Downlink Control |
| | Information |
| DF | Deployment Flavour |
| DL | Downlink |
| DMTF | Distributed |
| | Management Task |
| | Force |
| DPDK | Data Plane |
| | Development Kit |
| DM-RS, DMRS | Demodulation |
| | Reference Signal |
| DN | Data network |
| DNN | Data Network |
| | Name |
| DNAI | Data Network |
| | Access Identifier |
| DRB | Data Radio |
| | Bearer |
| DRS | Discovery |
| | Reference Signal |
| DRX | Discontinuous |
| | Reception |
| DSL | Domain Specific |
| | Language. Digital |
| | Subscriber Line |
| DSLAM | DSL |
| | Access Multiplexer |
| DwPTS | Downlink Pilot |
| | Time Slot |
| E-LAN | Ethernet |
| | Local Area Network |
| E2E | End-to-End |
| ECCA | extended clear |
| | channel assessment, |
| | extended CCA |
| ECCE | Enhanced |
| | Control Channel |
| | Element, |
| | Enhanced CCE |
| ED | Energy Detection |
| EDGE | Enhanced |
| | Datarates for GSM |
| | Evolution (GSM |
| | Evolution) |
| EAS | Edge |
| | Application Server |
| EASID | Edge |
| | Application Server |
| | Identification |
| ECS | Edge |
| | Configuration Server |
| ECSP | Edge Computing |
| | Service Provider |
| EDN | Edge Data Network |
| EEC | Edge Enabler Client |
| EECID | Edge Enabler Client |
| | Identification |
| EES | Edge Enabler Server |
| EESID | Edge Enabler Server |
| | Identification |
| EHE | Edge |
| | Hosting Environment |
| EGMF | Exposure Governance |
| | Management Function |
| EGPRS | Enhanced GPRS |
| EIR | Equipment |
| | Identity Register |
| eLAA | enhanced Licensed |
| | Assisted Access, |
| | enhanced LAA |
| EM | Element Manager |
| eMBB | Enhanced Mobile |
| | Broadband |
| EMS | Element |
| | Management System |
| eNB | evolved NodeB, |
| | E-UTRAN Node B |
| EN-DC | E-UTRA-NR |
| | Dual Connectivity |
| EPC | Evolved Packet |
| | Core |
| EPDCCH | enhanced PDCCH, |
| | enhanced Physical |
| | Downlink Control |
| | Cannel |
| EPRE | Energy per |
| | resource element |
| EPS | Evolved Packet |
| | System |
| EREG | enhanced REG, |
| | enhanced resource |
| | element groups |
| ETSI | European |
| | Telecommunications |
| | Standards Institute |
| ETWS | Earthquake and |
| | Tsunami Warning |
| | System |
| eUICC | embedded UICC, |
| | embedded Universal |
| | Integrated Circuit |
| | Card |
| E-UTRA | Evolved UTRA |
| E-UTRAN | Evolved UTRAN |
| EV2X | Enhanced V2X |
| F1AP | F1 Application |
| | Protocol |
| F1-C | F1 Control plane |
| | interface |
| F1-U | F1 User plane interface |
| FACCH | Fast Associated |
| | Control CHannel |
| FACCH/F | Fast |
| | Associated Control |
| | Channel/Full rate |
| FACCH/H | Fast |
| | Associated Control |
| | Channel/Half rate |
| FACH | Forward Access |
| | Channel |
| FAUSCH | Fast |
| | Uplink Signalling |
| | Channel |
| FB | Functional Block |
| FBI | Feedback Information |
| FCC | Federal |
| | Communications |
| | Commission |
| FCCH | Frequency |
| | Correction CHannel |
| FDD | Frequency |
| | Division Duplex |
| FDM | Frequency |
| | Division Multiplex |
| FDMA | Frequency Division |
| | Multiple Access |
| FE | Front End |
| FEC | Forward Error |
| | Correction |
| FFS | For Further Study |
| FFT | Fast Fourier |
| | Transformation |
| feLAA | further enhanced |
| | Licensed Assisted |
| | Access, further |
| | enhanced LAA |
| FN | Frame Number |
| FPGA | Field-Programmable |
| | Gate Array |
| FR | Frequency Range |
| FQDN | Fully Qualified |
| | Domain Name |
| G-RNTI | GERAN Radio |
| | Network Temporary |
| | Identity |
| GERAN | GSM EDGE RAN, |
| | GSM EDGE |
| | Radio Access |
| | Network |
| GGSN | Gateway GPRS |
| | Support Node |
| GLONASS | GLObal'naya |
| | NAvigatsionnay |
| | a Sputnikovaya |
| | Sistema (Engl.: |
| | Global Navigation |
| | Satellite System) |
| gNB | Next Generation |
| | NodeB |
| gNB-CU | gNB-centralized |
| | unit, Next Generation |
| | NodeB |
| | centralized unit |
| gNB-DU | gNB- |
| | distributed unit, Next |
| | Generation |
| | NodeB |
| | distributed unit |
| GNSS | Global |
| | Navigation Satellite |
| | System |
| GPRS | General Packet |
| | Radio Service |
| GPSI | Generic |
| | Public Subscription |
| | Identifier |
| GSM | Global System |
| | for Mobile |
| | Communications, |
| | Groupe Spécial |
| | Mobile |
| GTP | GPRS Tunneling |
| | Protocol |
| GTP-UGPRS | Tunnelling Protocol |
| | for User Plane |
| GTS | Go To Sleep Signal |
| | (related to WUS) |
| GUMMEI | Globally |
| | Unique MME Identifier |
| GUTI | Globally Unique |
| | Temporary UE |
| | Identity |
| HARQ | Hybrid ARQ, |
| | Hybrid Automatic |
| | Repeat Request |
| HANDO | Handover |
| HFN | HyperFrame Number |
| HHO | Hard Handover |
| HLR | Home Location |
| | Register |
| HN | Home Network |
| HO | Handover |
| HPLMN | Home Public |
| | Land Mobile Network |
| HSDPA | High |
| | Speed Downlink |
| | Packet Access |
| HSN | Hopping |
| | Sequence Number |
| HSPA | High Speed |
| | Packet Access |
| HSS | Home |
| | Subscriber Server |
| HSUPA | High |
| | Speed Uplink Packet |
| | Access |
| HTTP | Hyper Text |
| | Transfer Protocol |
| HTTPS | Hyper |
| | Text Transfer Protocol |
| | Secure (https is |
| | http/1.1 over |
| | SSL, i.e. port 443) |
| I-Block | Information |
| | Block |
| ICCID | Integrated Circuit |
| | Card Identification |
| IAB | Integrated |
| | Access and Backhaul |
| ICIC | Inter-Cell |
| | Interference |
| | Coordination |
| ID | Identity, identifier |
| IDFT | Inverse Discrete |
| | Fourier Transform |
| IE | Information element |
| IBE | In-Band Emission |
| IEEE | Institute of |
| | Electrical and |
| | Electronics Engineers |
| IEI | Information |
| | Element Identifier |
| IEIDL | Information |
| | Element Identifier |
| | Data Length |
| IETF | Internet Engineering |
| | Task Force |
| IF | Infrastructure |
| IM | Interference |
| | Measurement, |
| | Intermodulation, |
| IP | Multimedia |
| IMC | IMS Credentials |
| IMEI | International Mobile |
| | Equipment Identity |
| IMGI | International |
| | mobile group identity |
| IMPI | IP Multimedia |
| | Private Identity |
| IMPU | IP Multimedia |
| | PUblic identity |
| IMS | IP Multimedia |
| | Subsystem |
| IMSI | International Mobile |
| | Subscriber Identity |
| IoT | Internet of Things |
| IP | Internet Protocol |
| Ipsec | IP Security, |
| | Internet Protocol |
| | Security |
| IP-CAN | IP-Connectivity |
| | Access Network |
| IP-M | IP Multicast |
| IPv4 | Internet Protocol |
| | Version 4 |
| IPv6 | Internet Protocol |
| | Version 6 |
| IR | Infrared |
| IS | In Sync |
| IRP | Integration |
| | Reference Point |
| ISDN | Integrated Services |
| | Digital Network |
| ISIM | IM Services |
| | Identity Module |
| ISO | International |
| | Organisation for |
| | Standardisation |
| ISP | Internet Service |
| | Provider |
| IWF | Interworking-Function |
| I-WLAN | Interworking WLAN |
| | Constraint length |
| | of the convolutional |
| | code, USIM |
| | Individual key |
| kB | Kilobyte (1000 bytes) |
| kbps | kilo-bits per second |
| Kc | Ciphering key |
| Ki | Individual subscriber |
| | authentication key |
| KPI | Key |
| | Performance Indicator |
| KQI | Key Quality |
| | Indicator |
| KSI | Key Set Identifier |
| ksps | kilo-symbols per |
| | second |
| KVM | Kernel Virtual |
| | Machine |
| L1 | Layer 1 |
| | (physical layer) |
| L1-RSRP | Layer 1 |
| | reference signal |
| | received power |
| L2 | Layer 2 (data |
| | link layer) |
| L3 | Layer 3 |
| | (network layer) |
| LAA | Licensed Assisted |
| | Access |
| LAN | Local Area Network |
| LADN | Local Area |
| | Data Network |
| LBT | Listen Before Talk |
| LCM | LifeCycle |
| | Management |
| LCR | Low Chip Rate |
| LCS | Location Services |
| LCID | Logical |
| | Channel ID |
| LI | Layer Indicator |
| LLC | Logical Link |
| | Control, Low Layer |
| | Compatibility |
| LPLMN | Local PLMN |
| LPP | LTE Positioning |
| | Protocol |
| LSB | Least Significant |
| | Bit |
| LTE | Long Term Evolution |
| LWA | LTE-WLAN |
| | aggregation |
| LWIP | LTE/WLAN |
| | Radio Level |
| | Integration with |
| | IPsec Tunnel |
| LTE | Long Term |
| | Evolution |
| M2M | Machine-to-Machine |
| MAC | Medium Access |
| | Control (protocol |
| | layering context) |
| MAC | Message |
| | authentication code |
| | (security/encryption |
| | context) |
| MAC-A | MAC used for |
| | authentication |
| | and key |
| | agreement (TSG |
| | T WG3 context) |
| MAC-IMAC | used for |
| | data integrity of |
| | signalling messages |
| | (TSG T WG3 context) |
| MANO | Management and |
| | Orchestration |
| MBMS | Multimedia |
| | Broadcast and Multicast |
| | Service |
| MBSFN | Multimedia |
| | Broadcast multicast |
| | service Single |
| | Frequency Network |
| MCC | Mobile Country |
| | Code |
| MCG | Master Cell Group |
| MCOT | Maximum Channel |
| | Occupancy Time |
| MCS | Modulation and |
| | coding scheme |
| MDAF | Management Data |
| | Analytics Function |
| MDAS | Management Data |
| | Analytics Service |
| MDT | Minimization of |
| | Drive Tests |
| ME | Mobile Equipment |
| MeNB | master eNB |
| MER | Message Error |
| | Ratio |
| MGL | Measurement Gap |
| | Length |
| MGRP | Measurement Gap |
| | Repetition Period |
| MIB | Master Information |
| | Block, Management |
| | Information Base |
| MIMO | Multiple Input |
| | Multiple Output |
| MLC | Mobile Location |
| | Centre |
| MM | Mobility Management |
| MME | Mobility |
| | Management Entity |
| MN | Master Node |
| MNO | Mobile |
| | Network Operator |
| MO | Measurement |
| | Object, Mobile |
| | Originated |
| MPBCH | MTC Physical |
| | Broadcast CHannel |
| MPDCCH | MTC |
| | Physical Downlink |
| | Control CHannel |
| MPDSCH | MTC |
| | Physical Downlink |
| | Shared CHannel |
| MPRACH | MTC |
| | Physical Random |
| | Access CHannel |
| MPUSCH | MTC |
| | Physical Uplink Shared |
| | Channel |
| MPLS | MultiProtocol |
| | Label Switching |
| MS | Mobile Station |
| MSB | Most Significant |
| | Bit |
| MSC | Mobile |
| | Switching Centre |
| MSI | Minimum System |
| | Information, MCH |
| | Scheduling Information |
| MSID | Mobile Station |
| | Identifier |
| MSIN | Mobile Station |
| | Identification Number |
| MSISDN | Mobile Subscriber |
| | ISDN Number |
| MT | Mobile Terminated, |
| | Mobile Termination |
| MTC | Machine-Type |
| | Communications |
| mMTC | massive MTC, |
| | massive Machine- |
| | Type Communications |
| MU-MIMO | Multi User MIMO |
| MWUS | MTC wake-up |
| | signal, MTC WUS |
| NACK | Negative |
| | Acknowledgement |
| NAI | Network Access |
| | Identifier |
| NAS | Non-Access |
| | Stratum, Non-Access |
| | Stratum layer |
| NCT | Network |
| | Connectivity Topology |
| NC-JT | Non-Coherent |
| | Joint Transmission |
| NEC | Network Capability |
| | Exposure |
| NE-DC | NR-E-UTRA Dual |
| | Connectivity |
| NEF | Network |
| | Exposure Function |
| NF | Network Function |
| NFP | Network |
| | Forwarding Path |
| NFPD | Network |
| | Forwarding Path |
| | Descriptor |
| NFV | Network Functions |
| | Virtualization |
| NFVI | NFV |
| | Infrastructure |
| NFVO | NFV Orchestrator |
| NG | Next Generation, |
| | Next Gen |
| NGEN-DC | NG-RAN |
| | E-UTRA-NR Dual |
| | Connectivity |
| NM | Network Manager |
| NMS | Network |
| | Management System |
| N-PoP | Network Point |
| | of Presence |
| NMIB, N-MIB | Narrowband MIB |
| NPBCH | Narrowband Physical |
| | Broadcast CHannel |
| NPDCCH | Narrowband |
| | Physical Downlink |
| | Control CHannel |
| NPDSCH | Narrowband |
| | Physical Downlink |
| | Shared CHannel |
| NPRACH | Narrowband |
| | Physical Random |
| | Access CHannel |
| NPUSCH | Narrowband |
| | Physical Uplink |
| | Shared CHannel |
| NPSS | Narrowband Primary |
| | Synchronization Signal |
| NSSS | Narrowband |
| | Secondary |
| | Synchronization Signal |
| NR | New Radio, |
| | Neighbour Relation |
| NRF | NF Repository |
| | Function |
| NRS | Narrowband |
| | Reference Signal |
| NS | Network Service |
| NSA | Non-Standalone |
| | operation mode |
| NSD | Network Service |
| | Descriptor |
| NSR | Network Service |
| | Record |
| NSSAI | Network Slice |
| | Selection |
| | Assistance |
| | Information |
| S-NNSAI | Single-NSSAI |
| NSSF | Network Slice |
| | Selection Function |
| NW | Network |
| NWUS | Narrowband |
| | wake-up signal, |
| | Narrowband WUS |
| NZP | Non-Zero Power |
| O&M | Operation and |
| | Maintenance |
| ODU2 | Optical channel |
| | Data Unit—type 2 |
| OFDM | Orthogonal |
| | Frequency Division |
| | Multiplexing |
| OFDMA | Orthogonal |
| | Frequency Division |
| | Multiple Access |
| OOB | Out-of-band |
| OOS | Out of Sync |
| OPEX | OPerating EXpense |
| OSI | Other System |
| | Information |
| OSS | Operations |
| | Support System |
| OTA | over-the-air |
| PAPR | Peak-to-Average |
| | Power Ratio |
| PAR | Peak to Average |
| | Ratio |
| PBCH | Physical |
| | Broadcast Channel |
| PC | Power Control, |
| | Personal Computer |
| PCC | Primary |
| | Component Carrier, |
| | Primary CC |
| P-CSCF | Proxy CSCF |
| PCell | Primary Cell |
| PCI | Physical Cell ID, |
| | Physical Cell |
| | Identity |
| PCEF | Policy and Charging |
| | Enforcement Function |
| PCF | Policy Control |
| | Function |
| PCRF | Policy Control |
| | and Charging Rules |
| | Function |
| PDCP | Packet Data |
| | Convergence Protocol, |
| | Packet Data |
| | Convergence |
| | Protocol layer |
| PDCCH | Physical |
| | Downlink Control |
| | Channel |
| PDCP | Packet Data |
| | Convergence Protocol |
| PDN | Packet Data |
| | Network, Public |
| | Data Network |
| PDSCH | Physical |
| | Downlink Shared |
| | Channel |
| PDU | Protocol Data Unit |
| PEI | Permanent |
| | Equipment Identifiers |
| PFD | Packet Flow |
| | Description |
| P-GW | PDN Gateway |
| PHICH | Physical hybrid- |
| | ARQ indicator |
| | channel |
| PHY | Physical layer |
| PLMN | Public Land |
| | Mobile Network |
| PIN | Personal |
| | Identification Number |
| PM | Performance |
| | Measurement |
| PMI | Precoding |
| | Matrix Indicator |
| PNF | Physical |
| | Network Function |
| PNFD | Physical |
| | Network Function |
| | Descriptor |
| PNFR | Physical |
| | Network Function |
| | Record |
| POC | PTT over Cellular |
| PP, PTP | Point-to-Point |
| PPP | Point-to-Point |
| | Protocol |
| PRACH | Physical RACH |
| PRB | Physical |
| | resource block |
| PRG | Physical resource |
| | block group |
| ProSe | Proximity Services, |
| | Proximity-Based |
| | Service |
| PRS | Positioning |
| | Reference Signal |
| PRR | Packet |
| | Reception Radio |
| PS | Packet Services |
| PSBCH | Physical |
| | Sidelink Broadcast |
| | Channel |
| PSDCH | Physical Sidelink |
| | Downlink Channel |
| PSCCH | Physical |
| | Sidelink Control |
| | Channel |
| PSSCH | Physical |
| | Sidelink Shared |
| | Channel |
| PSCell | Primary SCell |
| PSS | Primary |
| | Synchronization |
| | Signal |
| PSTN | Public Switched |
| | Telephone Network |
| PT-RS | Phase-tracking |
| | reference signal |
| PTT | Push-to-Talk |
| PUCCH | Physical |
| | Uplink Control |
| | Channel |
| PUSCH | Physical |
| | Uplink Shared |
| | Channel |
| QAM | Quadrature |
| | Amplitude |
| | Modulation |
| QCI | QoS class of |
| | identifier |
| QCL | Quasi co- |
| | location |
| QFI | QoS Flow ID, |
| | QoS Flow Identifier |
| QoS | Quality of Service |
| QPSK | Quadrature |
| | (Quaternary) Phase |
| | Shift Keying |
| QZSS | Quasi-Zenith |
| | Satellite System |
| RA-RNTI | Random |
| | Access RNTI |
| RAB | Radio Access |
| | Bearer, Random |
| | Access Burst |
| RACH | Random Access |
| | Channel |
| RADIUS | Remote |
| | Authentication Dial In |
| | User Service |
| RAN | Radio Access Network |
| RAND | RANDom |
| | number (used for |
| | authentication) |
| RAR | Random Access |
| | Response |
| RAT | Radio Access |
| | Technology |
| RAU | Routing Area Update |
| RB | Resource block, |
| | Radio Bearer |
| RBG | Resource block |
| | group |
| REG | Resource Element |
| | Group |
| Rel | Release |
| REQ | REQuest |
| RF | Radio Frequency |
| RI | Rank Indicator |
| RIV | Resource |
| | indicator value |
| RL | Radio Link |
| RLC | Radio Link |
| | Control, Radio |
| | Link Control layer |
| RLC AM | RLC |
| | Acknowledged Mode |
| RLC UM | RLC |
| | Unacknowledged Mode |
| RLF | Radio Link |
| | Failure |
| RLM | Radio Link |
| | Monitoring |
| RLM-RS | Reference Signal |
| | for RLM |
| RM | Registration |
| | Management |
| RMC | Reference |
| | Measurement Channel |
| RMSI | Remaining MSI, |
| | Remaining |
| | Minimum System |
| | Information |
| RN | Relay Node |
| RNC | Radio Network |
| | Controller |
| RNL | Radio Network |
| | Layer |
| RNTI | Radio Network |
| | Temporary Identifier |
| ROHC | RObust Header |
| | Compression |
| RRC | Radio Resource |
| | Control, Radio |
| | Resource Control |
| | layer |
| RRM | Radio Resource |
| | Management |
| RS | Reference Signal |
| RSRP | Reference Signal |
| | Received Power |
| RSRQ | Reference Signal |
| | Received Quality |
| RSSI | Received Signal |
| | Strength Indicator |
| RSU | Road Side Unit |
| RSTD | Reference Signal |
| | Time difference |
| RTP | Real Time |
| | Protocol |
| RTS | Ready-To-Send |
| RTT | Round Trip Time |
| Rx | Reception, |
| | Receiving, Receiver |
| S1AP | S1 Application |
| | Protocol |
| S1-MME | S1 for |
| | the control plane |
| S1-U | S1 for the user |
| | plane |
| S-CSCF | serving CSCF |
| S-GW | Serving Gateway |
| S-RNTI | SRNC |
| | Radio Network |
| | Temporary |
| | Identity |
| S-TMSI | SAE |
| | Temporary Mobile |
| | Station Identifier |
| SA | Standalone |
| | operation mode |
| SAE | System Architecture |
| | Evolution |
| SAP | Service Access Point |
| SAPD | Service Access |
| | Point Descriptor |
| SAPI | Service Access |
| | Point Identifier |
| SCC | Secondary |
| | Component Carrier, |
| | Secondary CC |
| SCell | Secondary Cell |
| SCEF | Service |
| | Capability Exposure |
| | Function |
| SC-FDMA | Single Carrier |
| | Frequency Division |
| | Multiple Access |
| SCG | Secondary Cell |
| | Group |
| SCM | Security Context |
| | Management |
| SCS | Subcarrier |
| | Spacing |
| SCTP | Stream Control |
| | Transmission |
| | Protocol |
| SDAP | Service Data |
| | Adaptation Protocol, |
| | Service Data |
| | Adaptation |
| | Protocol layer |
| SDL | Supplementary |
| | Downlink |
| SDNF | Structured Data |
| | Storage Network |
| | Function |
| SDP | Session |
| | Description Protocol |
| SDSF | Structured Data |
| | Storage Function |
| SDU | Service Data |
| | Unit |
| SEAF | Security Anchor |
| | Function |
| SeNB | secondary eNB |
| SEPP | Security Edge |
| | Protection Proxy |
| SFI | Slot format |
| | indication |
| SFTD | Space-Frequency |
| | Time Diversity, SFN |
| | and frame timing |
| | difference |
| SFN | System Frame |
| | Number |
| SgNB | Secondary gNB |
| SGSN | Serving GPRS |
| | Support Node |
| S-GW | Serving Gateway |
| SI | System |
| | Information |
| SI-RNTI | System |
| | Information RNTI |
| SIB | System |
| | Information Block |
| SIM | Subscriber |
| | Identity Module |
| SIP | Session Initiated |
| | Protocol |
| SiP | System in |
| | Package |
| SL | Sidelink |
| SLA | Service Level |
| | Agreement |
| SM | Session |
| | Management |
| SMF | Session |
| | Management Function |
| SMS | Short Message |
| | Service |
| SMSF | SMS Function |
| SMTC | SSB-based |
| | Measurement Timing |
| | Configuration |
| SN | Secondary Node, |
| | Sequence Number |
| SoC | System on Chip |
| SON | Self-Organizing |
| | Network |
| SpCell | Special Cell |
| SP-CSI-RNTI | Semi-Persistent |
| | CSI RNTI |
| SPS | Semi-Persistent |
| | Scheduling |
| SQN | Sequence number |
| SR | Scheduling |
| | Request |
| SRB | Signalling Radio |
| | Bearer |
| SRS | Sounding |
| | Reference Signal |
| SS | Synchronization |
| | Signal |
| SSB | Synchronization |
| | Signal Block |
| SSID | Service Set |
| | Identifier |
| SS/PBCH | Block |
| SSBRI | SS/PBCH Block |
| | Resource Indicator, |
| | Synchronization |
| | Signal Block |
| | Resource Indicator |
| SSC | Session and |
| | Service Continuity |
| SS-RSRP | Synchronization |
| | Signal based |
| | Reference Signal |
| | Received Power |
| SS-RSRQ | Synchronization |
| | Signal based |
| | Reference Signal |
| | Received Quality |
| SS-SINR | Synchronization |
| | Signal based Signal to |
| | Noise and Interference |
| | Ratio |
| SSS | Secondary |
| | Synchronization |
| | Signal |
| SSSG | Search Space Set |
| | Group |
| SSSIF | Search Space Set |
| | Indicator |
| SST | Slice/Service Types |
| SU-MIMO | Single User MIMO |
| SUL | Supplementary |
| | Uplink |
| TA | Timing Advance, |
| | Tracking Area |
| TAC | Tracking Area Code |
| TAG | Timing Advance |
| | Group |
| TAI | Tracking |
| | Area Identity |
| TAU | Tracking Area |
| | Update |
| TB | Transport Block |
| TBS | Transport Block Size |
| TBD | To Be Defined |
| TCI | Transmission |
| | Configuration Indicator |
| TCP | Transmission |
| | Communication |
| | Protocol |
| TDD | Time Division |
| | Duplex |
| TDM | Time Division |
| | Multiplexing |
| TDMA | Time Division |
| | Multiple Access |
| TE | Terminal |
| | Equipment |
| TEID | Tunnel End |
| | Point Identifier |
| TFT | Traffic Flow |
| | Template |
| TMSI | Temporary |
| | Mobile |
| | Subscriber |
| | Identity |
| TNL | Transport |
| | Network Layer |
| TPC | Transmit Power |
| | Control |
| TPMI | Transmitted |
| | Precoding Matrix |
| | Indicator |
| TR | Technical Report |
| TRP, TRxP | Transmission |
| | Reception Point |
| TRS | Tracking |
| | Reference Signal |
| TRx | Transceiver |
| TS | Technical |
| | Specifications, |
| | Technical |
| | Standard |
| TTI | Transmission |
| | Time Interval |
| Tx | Transmission, |
| | Transmitting, |
| | Transmitter |
| U-RNTI | UTRAN |
| | Radio Network |
| | Temporary Identity |
| UART | Universal |
| | Asynchronous |
| | Receiver and |
| | Transmitter |
| UCI | Uplink Control |
| | Information |
| UE | User Equipment |
| UDM | Unified Data |
| | Management |
| UDP | User Datagram |
| | Protocol |
| UDSF | Unstructured |
| | Data Storage Network |
| | Function |
| UICC | Universal |
| | Integrated Circuit |
| | Card |
| UL | Uplink |
| UM | Unacknowledged Mode |
| UML | Unified |
| | Modelling Language |
| UMTS | Universal Mobile |
| | Telecommunications |
| | System |
| UP | User Plane |
| UPF | User Plane |
| | Function |
| URI | Uniform |
| | Resource Identifier |
| URL | Uniform |
| | Resource Locator |
| URLLC | Ultra- |
| | Reliable and Low |
| | Latency |
| USB | Universal Serial |
| | Bus |
| USIM | Universal |
| | Subscriber Identity |
| | Module |
| USS | UE-specific |
| | search space |
| UTRA | UMTS |
| | Terrestrial Radio |
| | Access |
| UTRAN | Universal |
| | Terrestrial Radio |
| | Access Network |
| UwPTS | Uplink |
| | Pilot Time Slot |
| V2I | Vehicle-to- |
| | Infrastruction |
| V2P | Vehicle-to- |
| | Pedestrian |
| V2V | Vehicle-to-Vehicle |
| V2X | Vehicle-to- |
| | everything |
| VIM | Virtualized |
| | Infrastructure Manager |
| VL | Virtual Link, |
| VLAN | Virtual LAN, |
| | Virtual Local Area |
| | Network |
| VM | Virtual Machine |
| VNF | Virtualized |
| | Network Function |
| VNFFG | VNF |
| | Forwarding Graph |
| VNFFGD | VNF |
| | Forwarding Graph |
| | Descriptor |
| VNFM | VNF Manager |
| VoIP | Voice-over-IP, |
| | Voice-over-Internet |
| | Protocol |
| VPLMN | Visited |
| | Public Land Mobile |
| | Network |
| VPN | Virtual Private |
| | Network |
| VRB | Virtual Resource |
| | Block |
| WiMAX | Worldwide |
| | Interoperability |
| | for Microwave |
| | Access |
| WLAN | Wireless Local |
| | Area Network |
| WMAN | Wireless |
| | Metropolitan Area |
| | Network |
| WPAN | Wireless |
| | Personal Area Network |
| X2-C | X2-Control plane |
| X2-U | X2-User plane |
| XML | eXtensible Markup |
| | Language |
| XRES | EXpected user |
| | RESponse |
| XOR | eXclusive OR |
| ZC | Zadoff-Chu |
| ZP | Zero Power |

### Terminology

For the purposes of the present document, the following terms and definitions are applicable to the examples and embodiments discussed herein.

The term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, and/or transferring digital data. Processing circuitry may include one or more processing cores to execute instructions and one or more memory structures to store program and data information. The term “processor circuitry” may refer to one or more application processors, one or more baseband processors, a physical central processing unit (CPU), a single-core processor, a dual-core processor, a triple-core processor, a quad-core processor, and/or any other device capable of executing or otherwise operating computer-executable instructions, such as program code, software modules, and/or functional processes. Processing circuitry may include more hardware accelerators, which may be microprocessors, programmable processing devices, or the like. The one or more hardware accelerators may include, for example, computer vision (CV) and/or deep learning (DL) accelerators. The terms “application circuitry” and/or “baseband circuitry” may be considered synonymous to, and may be referred to as, “processor circuitry.”

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “network element” as used herein refers to physical or virtualized equipment and/or infrastructure used to provide wired or wireless communication network services. The term “network element” may be considered synonymous to and/or referred to as a networked computer, networking hardware, network equipment, network node, router, switch, hub, bridge, radio network controller, RAN device, RAN node, gateway, server, virtualized VNF, NFVI, and/or the like.

The term “computer system” as used herein refers to any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The term “SMTC” refers to an SSB-based measurement timing configuration configured by SSB-MeasurementTimingConfiguration.

The term “SSB” refers to an SS/PBCH block.

The term “a “Primary Cell” refers to the MCG cell, operating on the primary frequency, in which the UE either performs the initial connection establishment procedure or initiates the connection re-establishment procedure.

The term “Primary SCG Cell” refers to the SCG cell in which the UE performs random access when performing the Reconfiguration with Sync procedure for DC operation.

The term “Secondary Cell” refers to a cell providing additional radio resources on top of a Special Cell for a UE configured with CA.

The term “Secondary Cell Group” refers to the subset of serving cells comprising the PSCell and zero or more secondary cells for a UE configured with DC.

The term “Serving Cell” refers to the primary cell for a UE in RRC_CONNECTED not configured with CA/DC there is only one serving cell comprising of the primary cell.

The term “serving cell” or “serving cells” refers to the set of cells comprising the Special Cell(s) and all secondary cells for a UE in RRC_CONNECTED configured with CA/.

The term “Special Cell” refers to the PCell of the MCG or the PSCell of the SCG for DC operation; otherwise, the term “Special Cell” refers to the Pcell.

1.-15. (canceled)

16. An apparatus comprising:
memory to store configuration information that includes a shared time domain resource allocation (TDRA) list associated with transport block over multiple slot (TBoMS) processing; and
processing circuitry, coupled with the memory, to:
retrieve the configuration information from the memory, wherein the TDRA list includes an entry having an indication of a scheduling delay (k2) and number of slots (N) for a TBoMS transmission; and
encode a message for transmission to a user equipment (UE) that includes the configuration information.

17. The apparatus of claim 16, wherein the entry further includes an indication of a number of repetitions (M) for the TBoMS transmission.

18. The apparatus of claim 17, wherein N=1 in the entry to indicate M is to be re-interpreted and applied by the UE for a single-slot physical uplink shared channel (PUSCH) transmission.

19. The apparatus of claim 18, wherein the entry further includes an indication that M is to be re-interpreted and applied by the UE for a single-slot physical uplink shared channel (PUSCH) transmission with repetitions.

20. The apparatus of claim 16, wherein the entry in the TDRA list includes: an indication of a start and length indicator value (SLIV) for the TBoMS transmission, or an indication of a mapping type for the TBoMS transmission.

21. One or more computer-readable media storing instructions that, when executed by one or more processors, cause a next-generation NodeB (gNB) to:
determine configuration information that includes a shared time domain resource allocation (TDRA) list associated with transport block over multiple slot (TBoMS) processing, wherein the TDRA list includes an entry having an indication of a scheduling delay (k2) and number of slots (N) for a TBoMS transmission; and
encode a message for transmission to a user equipment (UE) that includes the configuration information.

22. The one or more computer-readable media of claim 21, wherein the entry further includes an indication of a number of repetitions (M) for the TBoMS transmission.

23. The one or more computer-readable media of claim 22, wherein N=1 in the entry to indicate M is to be re-interpreted and applied by the UE for a single-slot physical uplink shared channel (PUSCH) transmission.

24. The one or more computer-readable media of claim 23, wherein the entry further includes an indication that M is to be re-interpreted and applied by the UE for a single-slot physical uplink shared channel (PUSCH) transmission with repetitions.

25. The one or more computer-readable media of claim 21, wherein the entry in the TDRA list includes: an indication of a start and length indicator value (SLIV) for the TBoMS transmission, or an indication of a mapping type for the TBoMS transmission.

26. One or more computer-readable media storing instructions that, when executed by one or more processors, cause a user equipment (UE) to:
receive a message from a next-generation NodeB (gNB) comprising configuration information that includes a shared time domain resource allocation (TDRA) list associated with transport block over multiple slot (TBoMS) processing, wherein the TDRA list includes an entry having an indication of a scheduling delay (k2) and number of slots (N) for a TBoMS transmission; and
encode a TBoMS message for transmission based on the configuration information.

27. The one or more computer-readable media of claim 26, wherein the entry further includes an indication of a number of repetitions (M) for the TBoMS transmission.

28. The one or more computer-readable media of claim 27, wherein N=1 in the entry to indicate M is to be re-interpreted and applied by the UE for a single-slot physical uplink shared channel (PUSCH) transmission.

29. The one or more computer-readable media of claim 28, wherein the entry further includes an indication that M is to be re-interpreted and applied by the UE for a single-slot physical uplink shared channel (PUSCH) transmission with repetitions.

30. The one or more computer-readable media of claim 26, wherein the entry in the TDRA list includes: an indication of a start and length indicator value (SLIV) for the TBoMS transmission, or an indication of a mapping type for the TBoMS transmission.
